(19) United States
(12) Patent Application Publication
(10) Pub. No.: US 2026/0203646 A1
(43) Pub. Date: Jul. 16, 2026

(54) BEHAVIOR-BASED REPRESENTATION GENERATION FOR PREDICTIVE TRAIT SYSTEMS

(71) Applicant: Twilio Inc., San Francisco, CA (US)

(72) Inventor: Carlos Alberto Oliveira, San Diego, CA (US)

(21) Appl. No.: 19/019,703

(22) Filed: Jan. 14, 2025

(51) Int. Cl. G06N 20/00; H04L 67/306

(52) U.S. Cl. CPC G06N 20/00; H04L 67/306

(57) ABSTRACT

A system and method for accessing, for each user of a set of users, user event data representing user events; generating a document for each user based on executing an aggregation function on the user event data; computing, for each user of the set of users, a user representation by using a trained machine-learning (ML) model and a generated document corresponding to the user. Responsive to detecting, at a predictive trait user interface (UI), a predictive trait selection, the method generates features for a predictive trait model based on a training set of users, trains the predictive trait model using the features; computes, using the trained predictive trait model, predictive trait values for a test set of users, and displays, at the predictive trait UI, explanations computed based on the computed predictive trait values, the training set, the test set, or the user representations.

### TECHNICAL FIELD

The disclosed subject matter relates generally to the technical field of prediction systems and, in one specific example, to a system for generating behavior-based user representations to be used in trait prediction.

### BACKGROUND

Efficiently building high-quality user profiles and/or predictive models of user traits for large user bases of platforms or consumer applications is an area of significant effort. Previous user modeling solutions typically use machine learning (ML) frameworks but the employed feature sets do not fully exploit the semantics of historical user data. Thus, the technical problem of efficiently augmenting a user modeling solution's feature set to increase the performance or explainability of user profiling and/or user trait prediction remains open. Additionally, previous user modeling solutions are limited in their handling of the ‘cold start’ problem, where predictions for new users or those with sparse activity are not timely and/or accurate. Mitigating the ‘cold start’ problem can thus lead to further improvements in user profiling and/or user trait prediction by improving the coverage of previous user modeling solutions.

### BRIEF DESCRIPTION OF THE SEVERAL VIEWS OF THE DRAWINGS

In the drawings, which are not necessarily drawn to scale, like numerals may describe similar components in different views. To easily identify the discussion of any particular element or act, the most significant digit or digits in a reference number refer to the figure number in which that element is first introduced. Some embodiments are illustrated by way of example, and not limitation, in the figures of the accompanying drawings.

FIG. 1 is a network diagram illustrating a system within which various example embodiments may be deployed.

FIG. 2 is a diagrammatic representation of a representation generator, according to some examples.

FIG. 3 is an illustration of visualizations of user representations, according to some examples.

FIG. 4 is an illustration of visualizations of user representations, according to some examples.

FIG. 5 is an illustration of visualizations of user representations, according to some examples.

FIG. 6 is an illustration of a visualization of a user representation, according to some examples.

FIG. 7 is an illustration of a visualization of a user representation, according to some examples.

FIG. 8 is an illustration of a visualization of a user representation, according to some examples.

FIG. 9 is an illustration of a visualization of a user representation, according to some examples.

FIG. 10 is a block diagram illustrating a view of a behavior-based predictive trait system that includes a framework for training, evaluating, or deploying trait prediction models, according to some examples.

FIG. 11 is a block diagram illustrating a view of a behavior-based predictive trait system, according to some examples.

FIG. 12 is a flowchart illustrating a method as implemented by a behavior-based predictive trait system, according to some examples.

FIG. 13 is an illustration of a view of a user interface (UI) for a behavior-based predictive trait system, according to some examples.

FIG. 14 is an illustration of a visualization of data related to trait prediction results within a UI for a behavior-based predictive trait system, according to some examples.

FIG. 15 is a block diagram illustrating an example of a software architecture that may be installed on a machine, according to some examples.

FIG. 16 is a block diagram illustrating components of a machine, according to some example embodiments, able to read instructions from a machine-readable medium (e.g., a machine-readable storage medium) and perform any one or more of the methodologies discussed herein.

FIG. 17 is a block diagram showing a machine-learning (ML) program, according to some examples.

### DETAILED DESCRIPTION

Businesses and marketers invest significant effort in developing and implementing quality marketing or e-mail campaigns, enabling message personalization or promoting customized and/or timely offers for products or experiences of interest to users.

To better understand how to target such efforts, current user profiling or customer relationship management (CRM) systems compute predictions of user trait values by computing, for example, a likelihood of a future user action and/or predefined conversion event over a future period of time (e.g., the next 30 days) for a particular user. Such systems can use machine learning (ML) models, relying on features like event frequency and/or event recency for predefined events (e.g., event IDs) within a predefined time window for feature computation. While such features are informative, they do not exploit the semantics and/or behavioral information encoded in the names of the user events and/or user actions, or in other text data associated with events, such for example user event descriptions or meta-data, URL text for pages associated with user events or actions, and so forth. However, such text data is informative with respect to actions taken by a user in a particular scenario, as well as useful for understanding types of users or user behaviors. Thus, there is a need for a system that can compute and/or process user representations that explicitly take into account textual information associated with user actions or events. Additionally, given a particular time window, a user may be associated with a limited number of events and/or actions—this is an example of a “cold start” problem. In order to compute predictions of user trait values for such users, there is a need for a system that can solve the “cold start” problem by being able to use limited behavioral data represented by a limited sample of events or actions.

Examples disclosed herein refer to a representation generator system and method for computing user representations based at least on text data associated with user events and/or actions. The explicit use of such data results in improved user profiles and/or improved predictions of user traits such as future user events and/or actions. In some examples, the representation generator is a component of, or connected to, a behavior-based predictive trait framework and/or system. The representation generator can automatically derive features and/or feature values based on such user representations and/or use them to augment or populate feature sets for predictive models that compute user-specific predictions of traits such as future events and/or actions. Responsive to detecting, at a predictive trait user interface (UI), a selection of a predictive trait, the behavior-based predictive trait system can construct a training set of users and/or a test set of users. The behavior-based predictive trait system and/or the representation generator can generate and/or access features and/or feature values associated with the users in the training set and/or test set, where the features are computed based on user representations generated for the respective users by the representation generator. The behavior-based predictive trait system can train a predictive trait model using at least the generated features, and/or compute, using the trained predictive trait model, predictive trait values for the one or more users in the test set. The behavior-based predictive trait system can display, at the predictive trait UI, explanations and/or visualizations associated with computed predictive trait values and/or the predictive trait model, where the explanations and/or visualizations are based on one or more of at least the computed predictive trait values, the training set, the test set, and/or the user representations.

In some examples, the representation generator accesses and/or receives user event data for a set of users, where the user event data corresponds to raw user data representing one or more user events and/or user actions. Given a user event or action, the corresponding user event data can include one or more text fields associated with each user event and/or action. Examples of such text fields include a name of the user event or action, a description of the user event or action, a type of the user event or action, a text of a URL associated with the user event or action, and so forth. In some examples, the user event data includes a time stamp associated with a respective user event and/or action.

Given a user and corresponding user event data, the representation generator uses one or more aggregation functions to compute a document for the respective user. The system can aggregate user events and/or actions at the level of time intervals of predetermined length (e.g., 1 hour, 1 day, etc.). Given such aggregated user events or actions and/or the time intervals of interest, the representation generator can determine a selection of processed or aggregated event data to be included in a generated document corresponding to the respective user. In some examples, given a time interval of interest and an associated aggregated event, event data corresponding to the aggregated event can include: time information indicating the time interval, frequency count indicating the number of times a user event descriptor (e.g., user event name, user event ID, user event type, etc.) has occurred during the time interval, one or more text fields associated with the respective user event or user event descriptor (e.g., user event name, user event description, user event type, text of a URL associated with the user event, etc.), and so forth. The representation generator can use one or more of a set of ordering criteria to order aggregated events and/or actions together with their associated event data in order to generate the document. For example, given a set of time intervals, the representation generator can order the time intervals in ascending and/or descending chronological order based on associated time stamp information. Furthermore, given the set of ordered time intervals, the representation generator can generate, for each time interval, a concatenation of the event data associated with each aggregated event of a set of aggregated events for the respective time interval. Each corresponding event data for an aggregated event can include, for example, a user event name and/or a frequency count of the user event during the time interval. In some examples, the representation generator can order the concatenated event data using the respective frequency counts (e.g., in decreasing or increasing order of the frequency counts, etc.).

Given a set of users and corresponding user-level documents generated as above, the representation generator can use a trained ML model to generate user representations based on the user-level documents. The representation generator computes the user representations by generating, for each user of the set of users, a user embedding vector with a preselected number of dimensions based on the generated user-level document. In some examples, the trained ML model is a pre-trained and/or fine-tuned embedding model. By using a pre-trained and/or fine-tuned embedding model, the representation generator can leverage prior external training and/or world knowledge, thereby enabling the generation of meaningful user representations even when starting with a sparse set of user actions and/or events. Thus, the representation generator and/or a larger system such as a predictive trait system or audience builder can handle users with limited data early on, instead of (or in addition to) waiting for a longer period of time to accumulate a significant amount of user events or actions. The use of a pre-trained and/or fine-tuned embedding model also reduces data processing needs, by mitigating training time and/or costs. In some examples, the representation generation can use an embedding model trained from scratch on data from a target business customer, target organization, target knowledge domain, and so forth. When a significant amount of user event data is available, such training of an embedding model from scratch can lead to a domain-specific embedding model useful for computing high-precision user representations.

In some examples, the representation generator processes (e.g., filters, clusters, etc.) the computed user representations to generate a set of processed user representations. For example, the representation generator can use one or more vector clustering algorithms to generate one or more user embedding clusters. In some examples, the representation generator and/or a feature generator can generate features for a predictive model based on the raw or processed user representation clusters. For example, for each cluster, a cluster-specific binary feature can have values indicating whether a particular user has a user representations that is a member of the respective cluster or not. In some examples, given N clusters, a n-ary feature can have a set of values such that value K indicates whether a particular user has a highest association or membership score with cluster K. Such features can be computed and/or used as part of a larger predictive trait system, as indicated above.

In some examples, the representation generator can be a component of, or connected to, an audience builder framework and/or system. Given a set of high-interest users (e.g., loyal users, least engaged users, etc.), the audience builder system can use the representation generator to compute representations for the high-interest users. The representation generator can compute and/or access user representations for additional, candidate users of a population of users. The audience builder system can use one or more similarity computation algorithms to identify candidate users whose user representations are similar and/or close to those of the users in the initial set of high-interest users (e.g., a lookalike audience). The audience builder can alternatively or additionally detect regularities, anomalies and/or patterns of a predetermined type by processing the user representations for the high-interest users, and/or the user representations for the candidate users.

Overall, examples in the disclosure herein refer to a system for deriving representations from user activity and/or history data and/or for using features based on such representations in behavior-based predictive trait value computation. The system can leverage pre-trained embedding models to compute user representations based on text associated with user events and actions, which are then used to enhance predictive accuracy for selected traits even in the absence of extensive historical data for users. This approach uses the additional semantic and/or behavioral information derived from the text of user actions or events, and/or mitigates the “cold start” problem common in traditional models, enabling new users to receive personalized experiences much sooner.

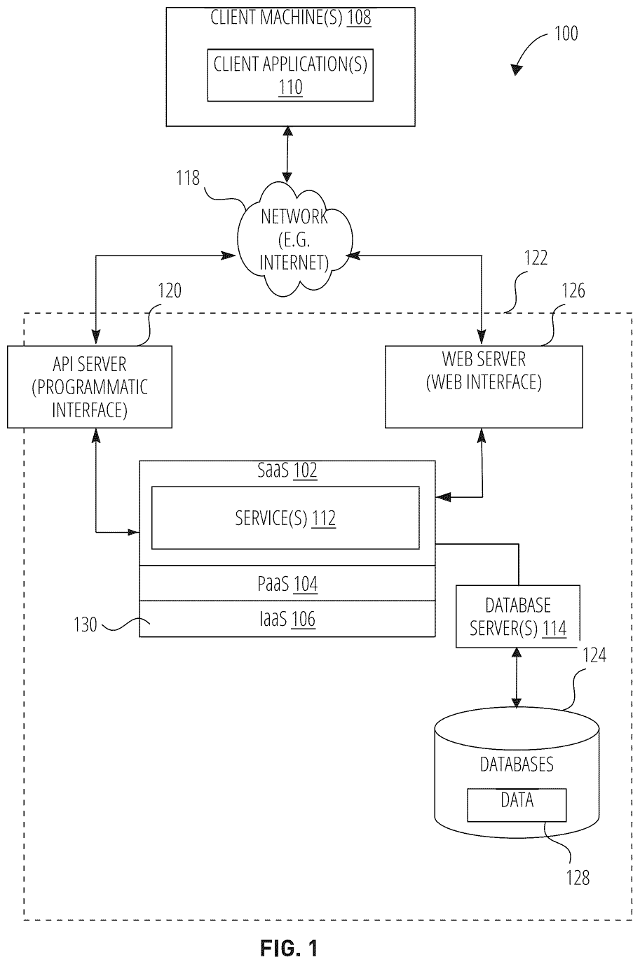

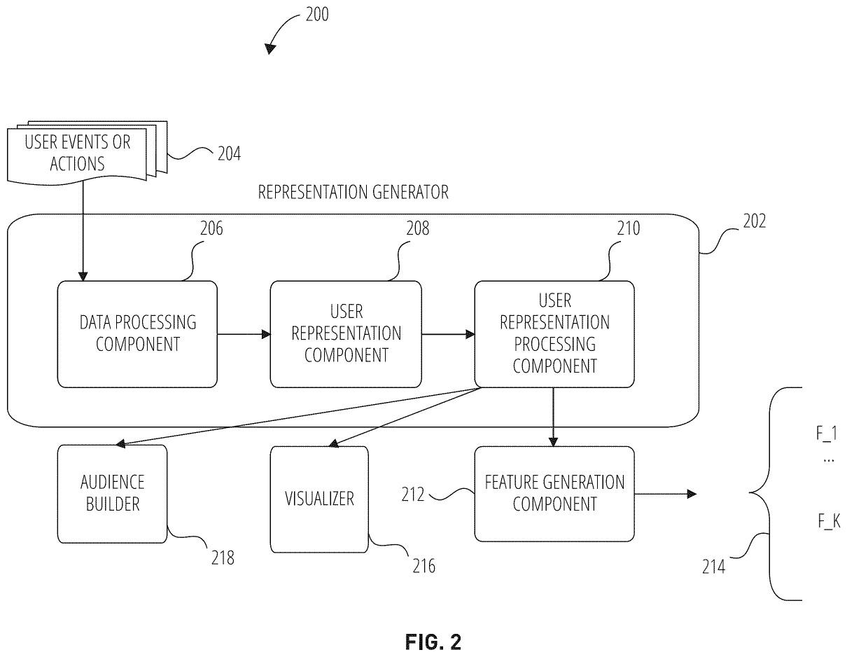

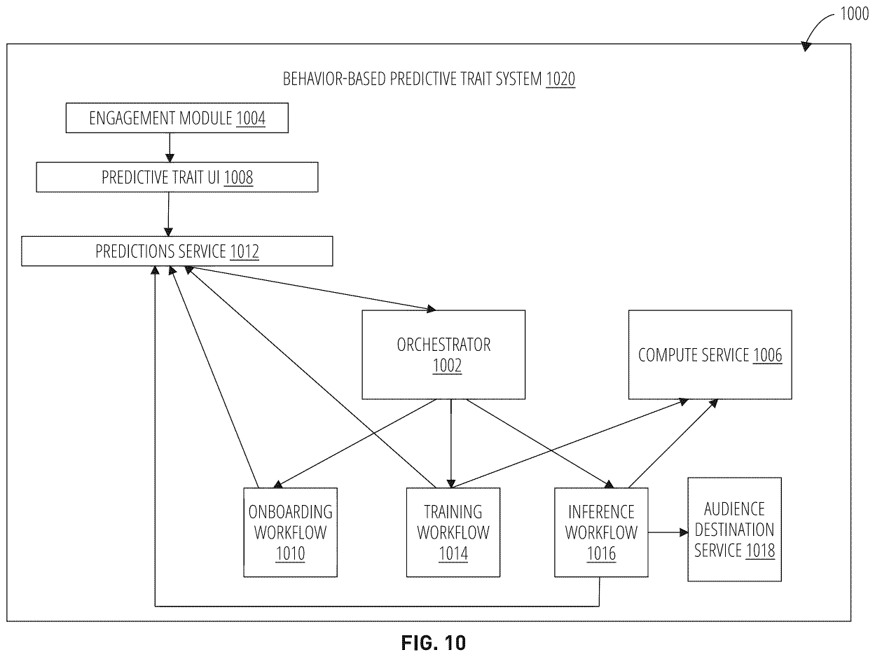

FIG. 1 is a network diagram depicting a system 100 within which various example embodiments may be deployed (such as a representation generator 202 illustrated in FIG. 2, or a larger behavior-based predictive trait system 1020 in FIG. 10). A networked system 122 in the example form of a cloud computing service, such as Microsoft Azure or other cloud service, provides server-side functionality, via a network 118 (e.g., the Internet or Wide Area Network (WAN)) to one or more endpoints (e.g., client machine(s) 108). FIG. 1 illustrates client application(s) 110 on the client machine(s) 108. Examples of client application(s) 110 may include a web browser application, such as the Internet Explorer browser developed by Microsoft Corporation of Redmond, Washington or other applications supported by an operating system of the device, such as applications supported by Windows, iOS or Android operating systems. Examples of such applications include e-mail client applications executing natively on the device, such as an Apple Mail client application executing on an iOS device, a Microsoft Outlook client application executing on a Microsoft Windows device, or a Gmail client application executing on an Android device. Examples of other such applications may include calendar applications, file sharing applications, and contact center applications. Each of the client application(s) 110 may include a software application module (e.g., a plug-in, add-in, or macro) that adds a specific service or feature to the application.

An API server 120 and a web server 126 are coupled to, and provide programmatic and web interfaces respectively to, one or more software services, which may be hosted on a software-as-a-service (SaaS) layer or platform 102. The SaaS platform may be part of a service-oriented architecture, being stacked upon a platform-as-a-service (PaaS) layer 104 which, may be, in turn, stacked upon a infrastructure-as-a-service (IaaS) layer 106 (e.g., in accordance with standards defined by the National Institute of Standards and Technology (NIST)).

While the applications (e.g., service(s)) 112 are shown in FIG. 1 to form part of the networked system 122, in alternative embodiments, the applications 112 may form part of a service that is separate and distinct from the networked system 122.

Further, while the system 100 shown in FIG. 1 employs a cloud-based architecture, various embodiments are, of course, not limited to such an architecture, and could equally well find application in a client-server, distributed, or peer-to-peer system, for example. The various server applications 112 could also be implemented as standalone software programs. Additionally, although FIG. 1 depicts machines 108 as being coupled to a single networked system 122, it will be readily apparent to one skilled in the art that client machine(s) 108, as well as client applications 110, may be coupled to multiple networked systems, such as payment applications associated with multiple payment processors or acquiring banks (e.g., PayPal, Visa, MasterCard, and American Express).

Web applications executing on the client machine(s) 108 may access the various applications 112 via the web interface supported by the web server 126. Similarly, native applications executing on the client machine(s) 108 may access the various services and functions provided by the applications 112 via the programmatic interface provided by the API server 120. For example, the third-party applications may, utilizing information retrieved from the networked system 122, support one or more features or functions on a website hosted by the third party. The third-party website may, for example, provide one or more promotional, marketplace or payment functions that are integrated into or supported by relevant applications of the networked system 122.

The server applications 112 may be hosted on dedicated or shared server machines (not shown) that are communicatively coupled to enable communications between server machines. The server applications 112 themselves are communicatively coupled (e.g., via appropriate interfaces) to each other and to various data sources, so as to allow information to be passed between the server applications 112 and so as to allow the server applications 112 to share and access common data. The server applications 112 may furthermore access one or more databases 124 via the database servers 114. In example embodiments, various data items are stored in the databases 124, such as the system's data items 128. In example embodiments, the system's data items may be any of the data items described herein.

Navigation of the networked system 122 may be facilitated by one or more navigation applications. For example, a search application (as an example of a navigation application) may enable keyword searches of data items included in the one or more databases 124 associated with the networked system 122. A client application may allow users to access the system's data items 128 (e.g., via one or more client applications). Various other navigation applications may be provided to supplement the search and browsing applications.

FIG. 2 is a diagrammatic representation of a representation generator 202, according to some examples. The representation generator 202 includes one or more of a data processing component 206, a user representation component 208, and a user representation processing component 210. The representation generator 202 takes as input data such as user events or actions 204, processes and/or aggregates it using the data processing component 206, uses the processed data to compute user representations using the user representation component 208, and/or further processes and/or aggregates the computed user representations via the user representation processing component 210. The computed and/or processed and/or aggregated representations can be transmitted to a feature generation component 212 to generate features for a machine learning (ML) model, such as for example, the predictive trait models described in FIG. 10. In some examples, the feature generation component 212 can be part of, or share functionality with, the representation generator 202. For illustrative purposes, the discussion herein employs users and user representations (e.g., user embeddings) as an example throughout-however, the representation generator 202 can be used to compute and/or process representations for other objects, such as query sessions or activity sessions, traits, properties, and so forth.

Given a user, user events or actions 204 can include a data set or history representing user actions or events. In some examples, user events or actions 204 includes K user actions or events that occur during a predetermined period of time (e.g., over N hours or days, in the N hours prior to a predetermined time or end of a time window, and so forth, with K being a constant). For example, given a user, user events or actions 204 can include data representing the last 256 events before the end of a predetermined window of time (e.g., a pre-determined feature computation window).

User event data representing a user event or user action can include text data or meta-data. Text data for a user event or user action can include, in some examples, a user event name, user event description, user event type, URL text for a URL associated with the user event, and so forth. Such text data can specify, for example, that an event is a “buy” event, while another is an “open page” or “click” event, and so forth.

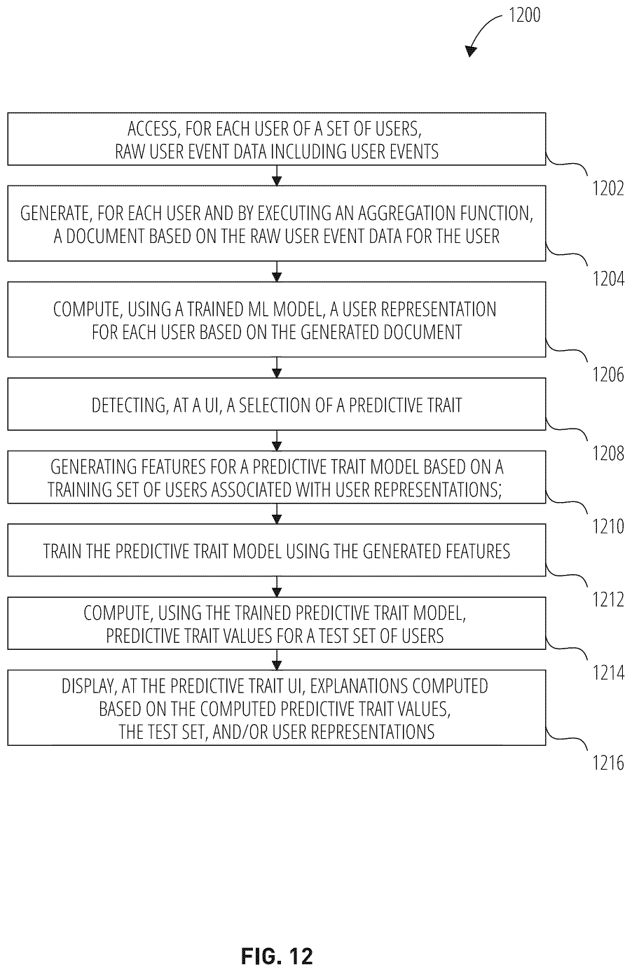

The data processing component 206 can process the user events or actions 204. For example, the data processing component 206 can extract, process and/or aggregate the text information associated with the user events or actions 204 (see, e.g., FIG. 12 for more details). Given a user, the data processing component 206 can use the text information associated with the user events or actions 204 corresponding to the user to generate at least one document. Thus, given a set of users, the data processing component 206 can generate a corpus of documents, where each of the user of the set of users is associated with one or more documents in the corpus.

Given a set of users and the set of corresponding user-specific documents, the user representation component 208 can use a trained embedding model to compute a user embedding with a preselected number of dimensions (e.g., 768 dimensions, etc.) for each user based on the associated user-specific document(s) for the respective user.

In some examples, the trained embedding model is a pre-trained model, such as for example a sentence transformers model such as hugginface.co/sentence-transformers/all-distilroberta-v1, or a Universal Sentence Encoder model, a Doc2Vec model, a FastText model, and so forth. Using a pre-trained model benefits from the large external corpora used to train the model, which encode significant and useful world knowledge. In cases in which the user history is limited, sparse, and/or the text associated with user events and user actions is short and/or informal, the use of a pre-trained model can greatly improve the automatic determining of user representations.

In some examples, the user representation component 208 or representation generator 202 can fine-tune the pre-trained model. In some examples, the user representation component 208 or representation generator 202 can train a dedicated embedding model for a specific use case. For example, given data from a business, organization or industry, the representation generator 202 can train business-specific or industry-specific models that can identify specific dynamics encompassing semantics embedded in the events or user actions collected and/or tracked. Such options are particularly useful if a large amount of user history data is or becomes available, as they allow the fine-tuning or training of an embedding model particularly relevant to a specific use case and/or application domain. In some examples, the representation generator 202 can use one or more pre-trained, fine-tuned and/or specifically-trained models to compute a set of potential user representations for each user.

Given a set of users, where each user is associated with a user representation (e.g., user embedding), the user representation processing component 210 can process the user representations corresponding to the set of users. For example, the user representation processing component 210 can apply one or more clustering algorithms to user embeddings, in order to identify clusters corresponding to user behavior patterns, user categories, and so forth. Examples of clustering algorithms include K-means clustering, affinity propagation, mean shift clustering, Density-Based Spatial Clustering of Applications with Noise (DBSCAN) and/or a hierarchical variant (HDBSCAN), other hierarchical clustering algorithms, and so forth.

In some examples, a feature generation component 212 can be used in connection with the output of the user representation processing component 210 or the output of the user representation component 208 to generate features for a predictive model, such as for example predictive trait models as in FIG. 10 (see, also, FIG. 12 for examples of feature generation methods).

In some examples, user representations and/or features produced by the representation generator 202 and/or the feature generation component 212 interact with, or are used by, alternative or additional components for various use cases.

For example, a lookalike audience builder 218 can incorporate a similar-user-retrieval component that takes as input a target user of interest (e.g., a core or high-interest user for a business), computes or retrieves a representation for the user based on a history of the user, and retrieves K most similar other users based on one or more measures of representation similarity (e.g., value of cosine similarity for the embedding vector for the target user and each of the embeddings for one or more other users). In some examples, the similar-user-retrieval component can take as input multiple target users (e.g., 100 users of particular interest to a business), identify a set of K most similar users for each target user, and use one or more aggregation procedures to combine the sets of retrieved similar users into a single ranked set of size K1 (e.g., the most similar 1700 users to the initial 100 users), which are returned as an output lookalike audience.

In some examples, a visualizer 216 can take as input representations produced and/or processed by the representation generator 202 and apply one or more algorithms to produce visualizations of the relationships among the representations, the representations including representation clusters, networks or graphs based on the representations, patterns of user behavior or activity and so forth. In some examples, the relationships and/or processing are performed by the user representation processing component 210 of the representation generator 202. In some examples, the production of such relationships and/or the user representation processing is shared between the representation generator 202 and the visualizer 216. The visualizer 216 can be interactive: upon receiving, at a user interface (UI) user input in the form of a user or user representation of interest, it can generate one or more views of the processed user representation data. In some examples, the visualizer 216 can display the most similar user representations based on an input user, one or more clusters including the specific user (ranked based on one or more criteria), a sub-graph of a similarity graph based on similarities among user representations, and so forth. The visualizer 216 can thus enable the browsing, querying and/or visualization of the user representations, the relationships among them, patterns derived based on them, and so forth.

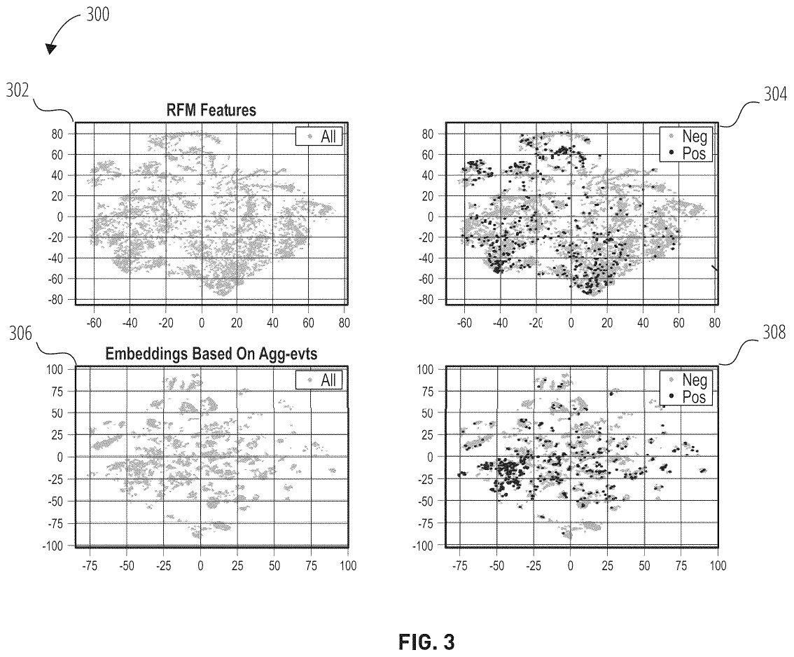

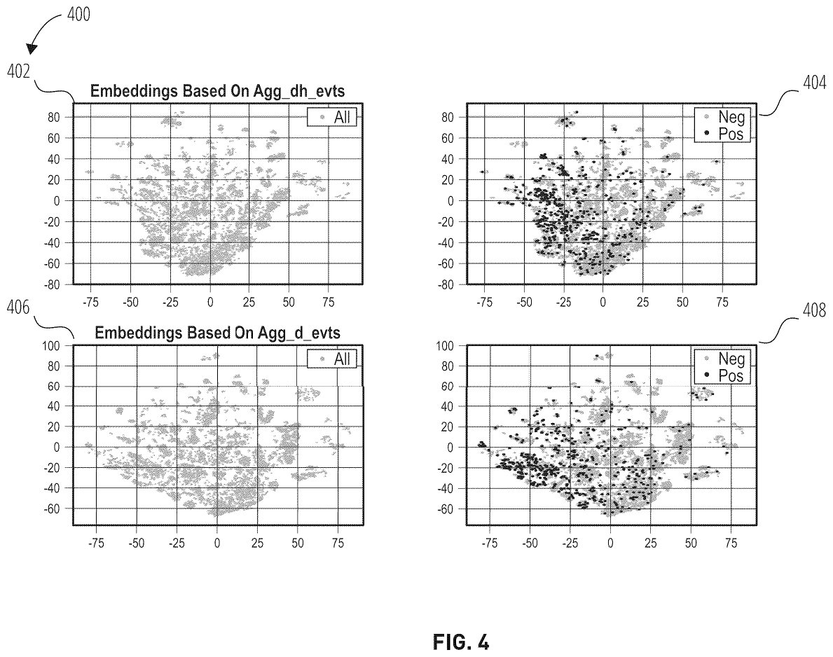

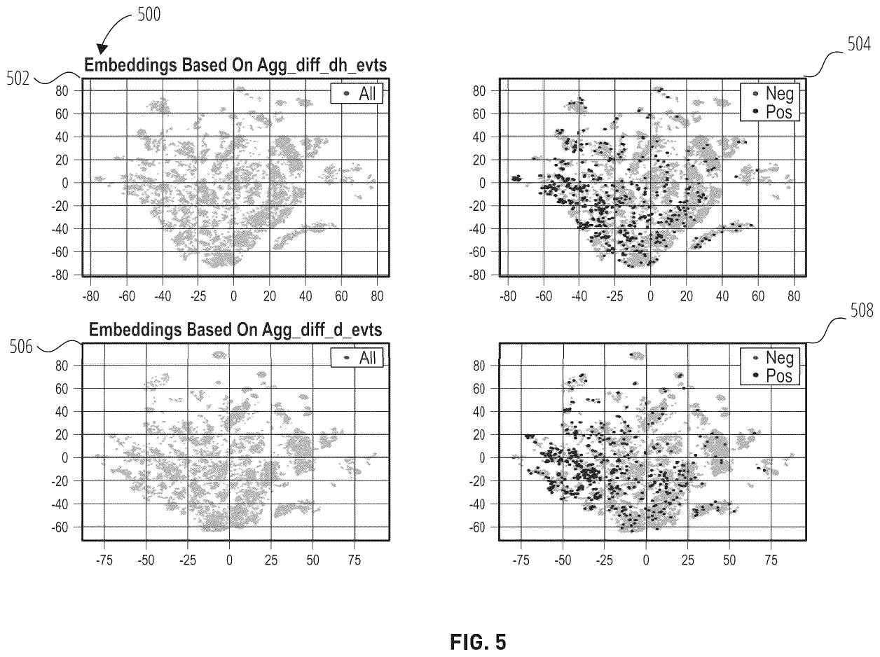

FIG. 3, FIG. 4 and FIG. 5 collectively correspond to a series of illustrations 300, 400 and 500 of visualizations of user representations, according to some examples, as implemented for example by the user representation processing component 210 of the representation generator 202.

Panel 302 illustrates a t-distributed stochastic neighbor embedding (t-SNE)-based visualization of a set of user representations based on a first representation generation procedure. Here, the representation generator 202 represents each of a set of users based on a set of features corresponding to the recency and/or frequency of a set of pre-defined user actions or events within a predetermined period of time before a target action (e.g., a target action such as buy_now_purchase_completed). The recency and/or frequency information is numerical, and the user representation computation uses no explicit textual information associated with the pre-defined user actions or events being used. The user representations, corresponding to user-level vectors, are visualized using the t-SNE algorithm, which has the effect of showing points corresponding to similar user vectors in close vicinity, and points corresponding to dissimilar user vectors as distant. Here, the t-SNE algorithm results in mapping the set of user representations corresponding to n-dimensional points to a set of points in 2D. As seen in panel 302, the non-textual information used to derive user representations is informative: the set of points in the visualization in 302 exhibits qualitative evidence of clusters corresponding to user patterns, where each cluster may correspond to a pattern, type of user, follow-up event or action, and so forth. Additionally, panel 302 shows qualitative evidence of some of the clusters appearing to have an elongated shape, which is typically observed when there are groups of points with low diversity of feature values of a subset of their features. Panel 304 corresponds to a view of the panel 302 including data points colored with one of two colors, where the darker color points correspond to users found to have taken the target action (positive examples) while the lighter color points correspond to users found to have not taken the target action (negative examples). As seen in panel 304, the non-textual features used do encode information that allows the formation of subclusters of positive examples for the target action.

Panel 306 shows a t-SNE-based visualization of user embeddings computed by the representation generator 202 based on user-level documents generated using textual information from user events or actions 204 (see FIG. 2). For each user, the data processing component 206 of the representation generator 202 computes a document using an aggregate event (agg_evts) strategy, which retains the description and/or name of user events or actions and their corresponding frequency counts within a predetermined period of time. An example such document is: “Sequence of events::products searched: 52×; screen viewed: 38×; product viewed: 38×; list of products viewed: 18×; watchlist added: 6×; user signed in: 1×; enquiry sent: 1×.” Given the set of users from panel 302 and a set of user-level documents generated in this manner, the representation generator 202 computes a set of user embeddings as detailed in FIG. 2. In this case, the representation generator 202 uses a pre-trained embedding model (e.g., huggingface.co/sentence-transformers/all-distilroberta-v1, etc.). The user representation processing component 210 (or the visualizer 216) can apply t-SNE and generate the visualization in panel 306. Panel 308 overlays the dark color and light color label indicators, corresponding to the positive examples for the target action and negative examples for the target action, onto the visualization in panel 304. Darker color data points correspond to positive examples. Lighter color data points correspond to negative examples. As can be seen in panel 308, there is qualitative evidence of larger clusters of positive examples than in panel 304, corresponding to a potential improvement from the use of embeddings based on user-level documents generated using the agg_evts strategy.

The rest of the panels in FIG. 4 and FIG. 5 include similar pairs of panels: given the set of users in panel 302 and panel 306, panels 402, 406, 502 and/or 506 show t-SNE-based visualizations of user embeddings computed by the representation generator 202 based on user-level documents generated using textual information from user events or actions 204 (see FIG. 2). The different panels showcase the results of using different user-level document generation strategies, detailed in Table 1 below. As Table 1 shows, example document generation strategies can experiment with different levels of aggregation, different lengths of time intervals within a time window, and so forth.

Panels 404, 408, 504, 508 overlay the differing color labels corresponding to the positive examples for the target action and negative examples for the target action, onto the visualizations in the corresponding panels 402, 406, 502, 506.

TABLE 1
Data processing strategies for generating user-level documents.

| | Document | |
|---|---|---|
| Panel | generation method | Example generated document |
| Panel | Aggregate | Sequence of events :: products searched: 52x; screen viewed: |
| 306 | events | 38x; product viewed: 38x; list of products viewed: 18x; |
| | (agg_evts) | watchlist added: 6x; user signed in: 1x; enquiry sent: 1x. |
| Panel | Aggregate | Sequence of events (precision: hour) :: 2024 Mar. 14 19:00:00: |
| 402 | events - hour | screen viewed 4x, list of products viewed 2x, product viewed 2x, |
| | interval | enquiry sent 1x; 2024 Mar. 11 04:00:00: product viewed 30x, |
| | (agg_dh_evts) | products searched 29x, screen viewed 7x, watchlist added 6x; |
| | | 2024 Mar. 3 19:00:00: screen viewed 8x; 2024 Feb. 27 07:00:00: |
| | | products searched 3x, screen viewed 1x; 2024 Feb. 27 06:00:00: |
| | | products searched 14x, screen viewed 3x, product viewed 2x; |
| | | 2024 Feb. 26 01:00:00: screen viewed 2x, products searched 2x, |
| | | product viewed 1x; 2024 Feb. 21 10:00:00: list of products |
| | | viewed 9x, screen viewed 7x, products searched 4x, product |
| | | viewed 3x; 2024 Feb. 20 17:00:00: list of products viewed 7x, |
| | | screen viewed 6x, user signed in 1x. |
| Panel | Aggregate | Sequence of events (precision: day) :: 2024 Mar. 14: screen |
| 406 | events - day | viewed 4x, list of products viewed 2x, product viewed 2x, |
| | interval | enquiry sent 1x; 2024 Mar. 11: product viewed 30x, products |
| | (agg_d_evts) | searched 29x, screen viewed 7x, watchlist added 6x; 2024 Mar. |
| | | 3: screen viewed 8x; 2024 Feb. 27: products searched 17x, |
| | | screen viewed 4x, product viewed 2x; 2024 Feb. 26: screen |
| | | viewed 2x, products searched 2x, product viewed 1x; 2024 Feb. |
| | | 21: list of products viewed 9x, screen viewed 7x, products |
| | | searched 4x, product viewed 3x; 2024 Feb. 20: list of products |
| | | viewed 7x, screen viewed 6x, user signed in 1x. |
| Panel | Aggregate | Sequence of events (precision: hour) :: 1 days, 5 hrs ago: |
| 502 | events - hour | screen viewed 4x, list of products viewed 2x, product viewed 2x, |
| | interval | enquiry sent 1x; 4 days, 20 hrs ago: product viewed 30x, |
| | (relative) | products searched 29x, screen viewed 7x, watchlist added 6x; |
| | (agg_diff_dh_evts) | 12 days, 5 hrs ago: screen viewed 8x; 17 days, 17 hrs ago: |
| | | products searched 3x, screen viewed 1x; 17 days, 18 hrs ago: |
| | | products searched 14x, screen viewed 3x, product viewed 2x; |
| | | 18 days, 23 hrs ago: screen viewed 2x, products searched 2x, |
| | | product viewed 1x; 23 days, 14 hrs ago: list of products viewed |
| | | 9x, screen viewed 7x, products searched 4x, product viewed 3x; |
| | | 24 days, 7 hrs ago: list of products viewed 7x, screen viewed |
| | | 6x, user signed in 1x. |
| Panel | Aggregate | Sequence of events (precision: day) :: 2 days ago: screen |
| 506 | events - day | viewed 4x, list of products viewed 2x, product viewed 2x, |
| | interval | enquiry sent 1x; 5 days ago: product viewed 30x, products |
| | (relative) | searched 29x, screen viewed 7x, watchlist added 6x; 13 days |
| | (agg_diff_d_evts) | ago: screen viewed 8x; 18 days ago: products searched 17x, |
| | | screen viewed 4x, product viewed 2x; 19 days ago: screen |
| | | viewed 2x, products searched 2x, product viewed 1x; 24 days |
| | | ago: list of products viewed 9x, screen viewed 7x, products |
| | | searched 4x, product viewed 3x; 25 days ago: list of products |
| | | viewed 7x, screen viewed 6x, user signed in 1x. |

As can be seen in panels 308, 404, 408, 504 and 508, there is qualitative evidence that the user embeddings computed based on text documents generated as described in Table 1 can lead to the formation of (sub)groups or (sub)clusters of positive examples for the target action (e.g., users who have undertaken the target action). Different granularities of information used to create the user documents correspond to different levels of clustering in the t-SNE plots. For example, the agg_d_evts document generation strategy helps to uncover sub-patterns of the patterns resulting from the use of the agg_evts strategy, while agg_dh_evts helps to uncover further details when compared to agg_d_evts. Overall, the visualizations in FIG. 3, FIG. 4 and FIG. 5 illustrate an example of the potential benefit of using textual data associated with user actions or events, in conjunction with a pre-trained embedding model leveraging external world and/or semantic knowledge.

In some examples, the representation generator 202 or the visualizer 216 can compute one or more measures indicating which of the document generation strategies performs best on a set (e.g., development set) of positive and/or negative examples. For example, the representation generator 202 can compute, for a given document generation strategy, a measure indicating the average similarity (or distance) over pairs of positive examples between the elements of corresponding user embedding pairs. The representation generator 202 can select the document generation strategy that optimizes the respective measure (e.g., maximizes the average similarity for pairs of positive examples).

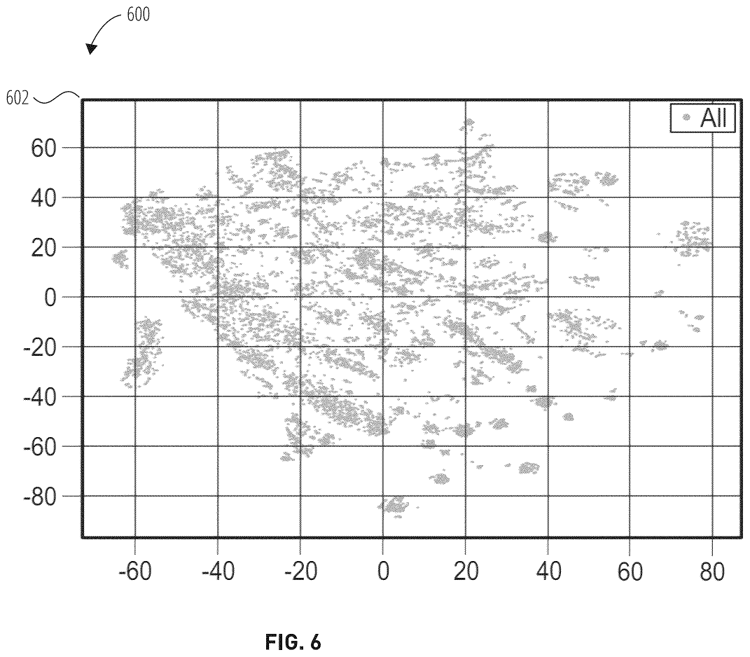

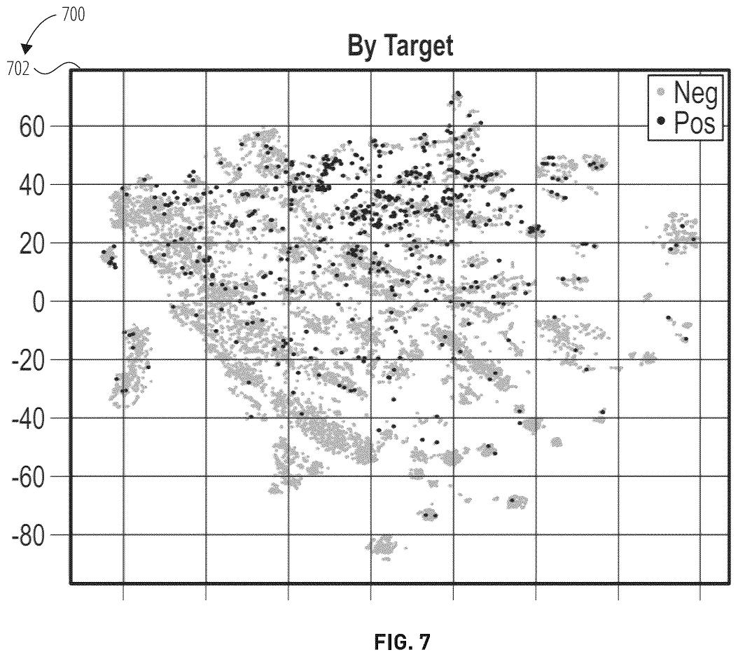

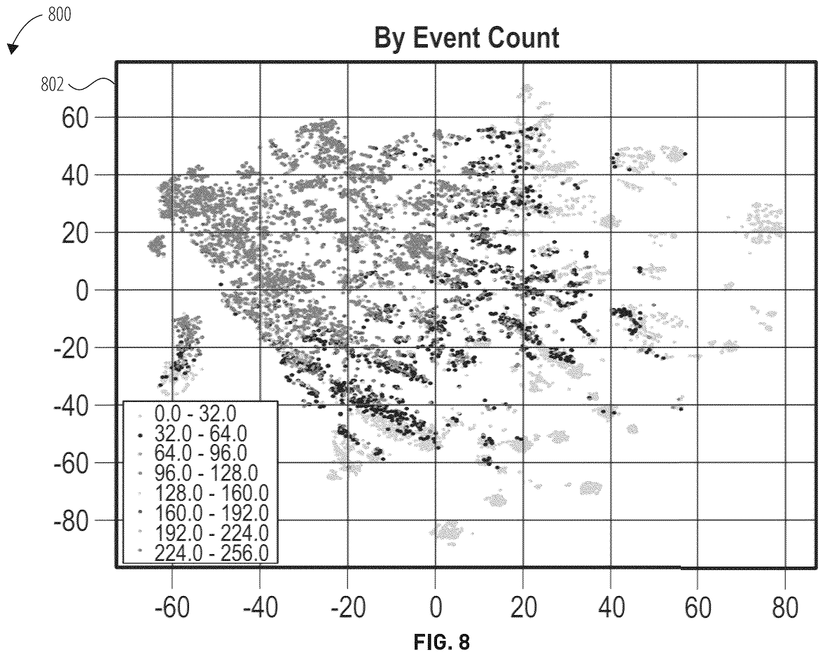

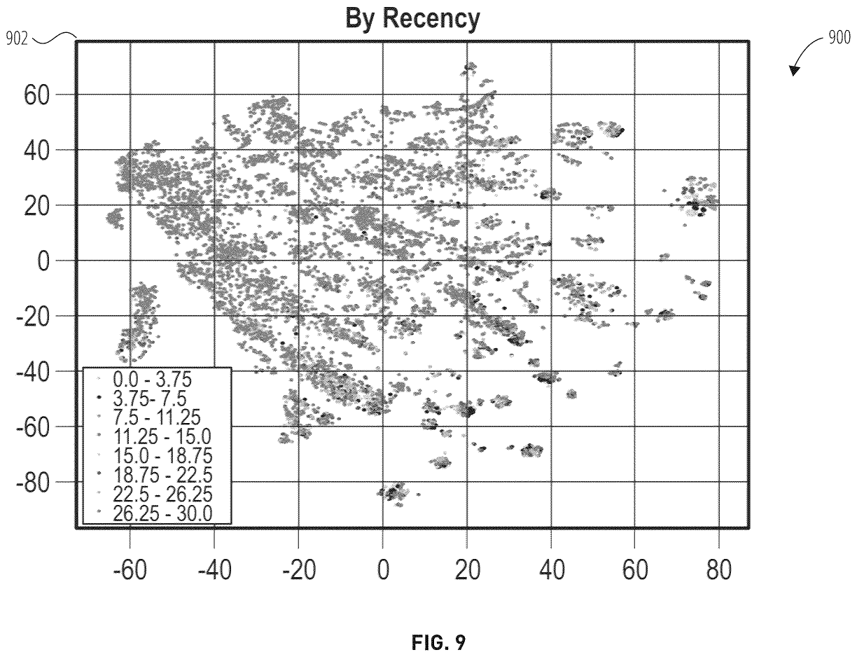

FIG. 6, FIG. 7, FIG. 8 and FIG. 9 collectively correspond to illustrations 600, 700, 800 and 900 of visualizations of user representations, according to some examples, as implemented for example by the user representation processing component 210 of the representation generator 202.

Panel 602 shows a t-SNE-based visualization of user embeddings computed by the representation generator 202 based on user-level documents generated using textual information from user events or actions 204 (see FIG. 2). In this example, for each user, the data processing component 206 of the representation generator 202 computes a document using an agg_diff_dh_evts strategy (see, e.g., Table 1 above). Given the set of users from panel 602 and a set of user-level documents generated in this manner, the representation generator 202 computes a set of user embeddings as detailed in FIG. 2. Here, the representation generator 202 uses a pre-trained embedding model (e.g., huggingface.co/sentence-transformers/all-distilroberta-v1). The user representation processing component 210 (or the visualizer 216) can apply t-SNE and generate the visualization in panel 602.

Panel 702 overlays, onto the visualization in panel 602, dark color and light color labels indicating positive examples for the target action and, respectively, negative examples for the target action.

Panel 802 overlays, onto the visualization in panel 602, differing color labels corresponding to event count buckets (e.g., each event count bucket corresponds to an event count between a predetermined minimum value MIN and a predetermined maximum value MAX (e.g., [MIN=0.0, MAX=32.0]), where the event count is determined over a predefined period of time.

Panel 902 overlays, onto the visualization in panel 602, differing color labels corresponding to recency-based buckets. Each such bucket corresponds to an interval between a predetermined end point END and a predetermined start point START (e.g., [END=0.0, START=3.75] corresponds to a period of time ending at present and starting 3.75 days ago, etc.).

As can be seen in panel 702, there is qualitative evidence that the user embeddings computed as detailed above and/or visualized in panel 602, can be used to determine (sub)groups or (sub)clusters of positive examples for the target action (e.g., users who have undertaken the target action). As can be seen in panels 802 and 902, there is qualitative evidence that the text-based embeddings do indicate or recover event frequency and/or recency regularities and/or patterns.

FIG. 10 is a block diagram 1000 illustrating a view of a behavior-based predictive trait system 1020 that includes a framework for creating, training and/or deploying predictive trait models, according to some examples.

Predictive trait models are ML models that predict values of traits and/or associated likelihood scores. Traits (e.g., predictive traits) correspond to user actions, predefined events (e.g., conversion events such as a user purchase or a user click event, events involving one or more user actions, etc.), user behaviors, user attributes, and other trait types. Traits or actions can include customer lifetime value (LTV), purchase actions (e.g., for specific objects or types of purchases), repeating purchase actions, customer churn, and so forth. Predicting trait values can refer to automatically determining whether a user will take (or forgo) a pre-defined action during or over a future time period and/or computing a likelihood of a user taking (or forgoing) the pre-defined action during or over the future time period, automatically determining whether a pre-defined event will take place (or not) during or over a future time period and/or computing a likelihood of the pre-defined event taking place (or not) during or over the future time period, computing the likelihood of a particular value for a user behavior or attribute, computing an estimated value of a particular user behavior, attribute or other user-involved trait, and other types of prediction and estimation. The future time period can have a predefined duration (e.g., the next 7/14/30 days, etc.).

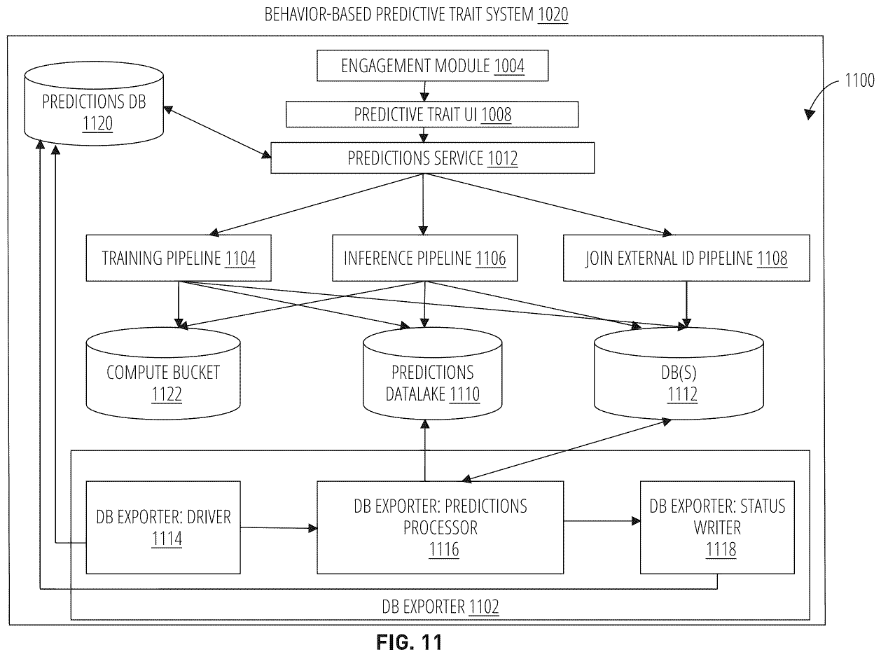

In some examples, behavior-based predictive trait system 1020 includes one or more of an engagement module 1004, a predictive trait UI 1008 and a predictions service 1012. The engagement module 1004 allows a system user (e.g., a marketer, a business, etc.) to start engaging with the system (e.g., by selecting a prediction user selectable UI element that indicates an interest in using a predictive trait model). The predictive trait UI 1008 includes selectable UI elements that, upon selection by the system user, allow the user to choose one or more of a set of traits for which to compute a prediction, configure a specific predictive trait, or create and/or configure a new predictive trait. For example, the system user can configure an already selected predictive LTV trait by selecting an “order_completed” event and a “revenue” property (see at least FIG. 11 for details).

Once a trait has been selected, configured and/or created by a user via the predictive trait UI 1008, the predictive trait UI 1008 executes one or more calls (e.g., API calls) to the predictions service 1012, which is responsible for running pipelines for training trait-specific models and/or pipelines for performing inference using trained trait-specific models.

Predictive trait models can use one or more types of data for constructing/augmenting a training set and/or generating features. Features can be raw features, or transformed and/or aggregated features. In some examples, a trait can have a dedicated feature set. Feature generation can be implemented by a feature generation system such as, for the example, the feature generation component 212. As detailed in FIG. 2, feature generation component 212 can be used in connection with the output of the user representation processing component 210 or the output of the user representation component 208.

In some examples, features can be derived based on user profiles, explicit and/or provided user attributes and/or categories (e.g., user-provided location or age, user-provided topic interests, etc.), inferred user attributes, categories and/or interests, and/or user behaviors. Data relevant to inferring or capturing user behaviors can include a stream of data representing user-level events and/or actions (e.g., an event stream or action stream, etc.). Such data streams can include timestamp information (e.g., minute/hour/day, day of the week, week of the year, month of the year, etc.) or activity intervals. In some examples, user profile or user trait data in a data stream is processed to remove personal identification information (PII). In the following, the example of an event stream is used as an illustrative example of a data stream only.

Given a user-specific event stream, features can include event-stream based features and/or timestamp-related features (e.g., number of page visits in the past K days by a user, average time between page visits in the past K days by a user, time of last page visit by a user in the past K days, etc.). Additional examples of features that capture information such as frequency, recency, trends or ratios derived based on a sequence of recorded events or actions for each user include: number of purchases on day N of the week in the last M weeks, average time between product page views per session, number of clicks on website button B per visit, ratio of cart additions to completed purchases per session, and so forth. Such features can capture frequency or recency information for a set of predefined user events or actions within a predetermined time window. In such cases, the feature generation component 212 relies on a set of predefined user events or actions of interest (e.g., each associated with an ID) and processes a user-specific event stream to compute the features described. While already informative, this feature generation process can be augmented by explicitly taking into account the text data associated with each of the events or actions in the event stream, and/or ordering information of the events or actions within the event stream, as detailed in FIG. 2. Given a set of user representations generated and/or processed by the representation generator 202, the feature generation component 212 can use such user representations to compute features for the predictive trait models. For example, given a set of user embeddings computed and/or clustered by the representation generator 202, the feature generation component 212 can compute cluster-based features for one or more predictive trait models.

In some examples, the behavior-based predictive trait system 1020 determines that multiple personas, views, or IDs for an entity (e.g., a user) are associated with a single canonical ID corresponding to the entity (e.g., user). If so, the feature generation component 212 can aggregates feature values for each relevant feature and computes aggregate feature values associated with the canonical ID and/or entity or user. The behavior-based predictive trait system 1020 can then execute predictions or computations at the level of canonical IDs or entities. For example, the behavior-based predictive trait system 1020 predicts the likelihood of a future conversion event (such as a click event or purchase event) associated with a canonical ID and/or a group of merged personas/views/IDs.

The predictions service 1012 communicates with an orchestrator 1002 (e.g., a component of the behavior-based predictive trait system 1020, for instance a Conductor orchestration engine managed by Orkes, or an orchestration engine within any other workflow orchestration platform). The orchestrator 1002 schedules workflows such as onboarding workflow 1010, a training workflow 1014 and an inference workflow 1016. The workflows run one or more processes related to the training, evaluation, and/or deployment of models for predicting selected traits.

In some examples, the onboarding workflow 1010 starts subsequent to the detection, by the orchestrator 1002, of a communication from the predictions service 1012. An example such communication comprises information about a selected and/or configured trait for which to build, evaluate, or deploy a prediction model. The onboarding workflow 1010 can start in response to the behavior-based predictive trait system 1020 detecting that a system user requests access to the predictive trait UI or predictive trait functionality, for example by engaging with the predictive trait UI 1008 as described above. In some examples, the onboarding workflow 1010 creates a system user (or customer) workspace, used for example to enable database (DB) exports of needed customer data, as detailed in the FIG. 11 discussion. The onboarding workflow 1010 enables a feature flag indicating that the user has access to the predictive trait (or trait prediction) functionality starting at a specific point in time. The onboarding workflow 1010 communicates with the predictions service 1012 to transmit namespace information (e.g., customer information).

In some examples, a training workflow 1014 runs a training process. The training workflow 1014 checks whether it has access to a set of necessary data or DB exports (e.g., necessary customer data for a given period, etc.). The training workflow 1014 creates a training set (e.g., a training audience) and runs a training pipeline 1104 for a model (e.g., a machine learning model) that predicts a selected, customized trait (e.g., predicting the likelihood of a future action or conversion event, etc.) The training workflow 1014 creates a training set (e.g., training audience) by using a compute service 1006. The training workflow 1014 can store the data about the members of the training audience either locally, or in remote storage. The behavior-based predictive trait system 1020 periodically computes and/or monitors a comprehensive set of metrics to ensure the health of production models. Such measures track various stability indicators for model performance over time and over populations or specific characteristics (e.g., a Population Stability Index, a Characteristics Stability Index, etc.). The behavior-based predictive trait system 1020 uses a set of criteria and operations/decision logic to trigger model retraining, fresh data collection, and/or other steps in order to improve the health of the deployed models. The training workflow 1014 retrains a trained model with fresh data using a time-based schedule and/or a performance-based schedule (e.g., daily/weekly/monthly, etc., triggered by a drop in a periodically-assessed performance of the model, or based on other pre-defined triggering events).

In some examples, an inference workflow 1016 runs an inference process. The inference workflow 1016 creates an evaluation or test set (e.g., an inference audience). The inference workflow 1016 runs an inference pipeline 1106 and/or a join external ID pipeline 1108. The inference pipeline 1106 retrieves a trained prediction model for a trait and computes prediction results for the trait of interest over the evaluation or test set (e.g., for each customer included in the test set or inference audience). The trait prediction results are synchronized with user profiles and/or specific destinations within an audience destination service 1018. Post-inference outputs (e.g., percentiles, stats, other model explainability quantities, null trait values for non-active users) are computed, for example by the join external ID pipeline 1108 (see FIG. 11). Such post-inference outputs are uploaded or synchronized, by the inference workflow 1016 via a sync workflow with audience destination service 1018. Such post-inference outputs correspond to explanations associated with the predictive trait values and/or with the predictive trait model or behavior-based predictive trait system 1020. The post-inference outputs and/or explanations can be displayed to the system user via one or more UIs, such the predictive trait UI 1008.

FIG. 11 is a block diagram 1100 illustrating a view of a behavior-based predictive trait system 1020 that includes a framework for creating, training, and/or deploying predictive trait models, according to some examples.

In some examples, predictions service 1012 of a behavior-based predictive trait system 1020 runs a training pipeline 1104, created for example by a training workflow 1014. The training pipeline 1104 retrieves relevant customer data (e.g., user profile data for members of the training set or training audience, constructed for instance by training workflow 1014), from one or more databases or datalakes such as the predictions datalake 1110, DB(s) 1112, and/or remote storage such as cloud storage. Audience membership data is read or accessed from its local or remote storage. For example, such data is stored by the compute service 1006 in the compute bucket 1122, which corresponds to cloud storage (e.g., AWS storage such as an Amazon S3 bucket, Google Cloud Storage, Microsoft Azure Storage, etc.) The training pipeline assembles the relevant data for each member of the training set (or training audience) by accessing and combining user profile data and audience membership data. In some examples, the training pipeline 1104 reads lean events from the predictions datalake 1110. In some examples, the training pipeline 1104 reads lifetime value (LTV) event properties (e.g., track event properties), and a latest version of merge tables, from one or more DB(s) 1112.

After the training pipeline 1104 retrieved the relevant customer data for the trait of interest and the training test of interest, the training pipeline 1104 trains a new model (e.g., ML model) corresponding to the trait of interest (e.g, a predictive LTV model, a model for predicting likelihood to purchase, etc.). A trained model for a specific interest can be evaluated by comparing it with a baseline model. If the behavior-based predictive trait system 1020 automatically assesses that the trained model meets one or more predetermined performance-related thresholds (e.g., accuracy on a held-out set, performance superior to a baseline model on a held-out set, etc.), the trained model is used for inference.

The predictions service 1012 runs an inference pipeline 1106 (e.g., as part of the inference workflow 1016), which can include retrieving a trained trait-specific model and/or running it for each member of a test set or inference audience. The test set is created as part of the inference workflow 1016, using for example a compute service 1006. The test set is stored in local or remote storage (e.g., cloud storage such as cloud compute bucket 1122) for the respective compute service. The test set is accessed (read) by the inference pipeline 1106. In order to run a trained model on each inference audience member, inference pipeline 1106 assembles the relevant data for each inference audience member (e.g., from predictions datalake 1110, DB(s) 1112, etc.). The inference pipeline 1106 reads lean events (e.g., from predictions datalake 1110), event properties (e.g., for LTV), and/or latest version of merge tables (e.g., from databases 124).

After the inference pipeline 1106 finishes the model run, the predictions service 1012 can run a join external ID pipeline 1108, which join the results of the inference pipeline (e.g., computed prediction(s) for each member of the inference audience) with external ID tables (e.g., as required by an audience destination service 1018). In some examples, the external ID tables are read from storage such as from one or more DB(s) 1112, etc. The join external ID pipeline 1108 can compute post-inference outputs (e.g., percentiles, stats, model explainability-related quantities, etc.), and/or indicate or mark null trait values for users with low or no activity according to one or more activity-related predetermined thresholds. In some examples, the inference pipeline 1106 and join external ID pipeline 1108 are part of an inference workflow 1016 (see FIG. 10). The inference workflow 1016 can upload predictions (e.g., results of the inference pipeline 1106) to user profiles and/or destinations within an audience destination service 1018.

In some examples, the behavior-based predictive trait system 1020 includes a DB exporter 1102, which in turn may include a DB exporter: driver 1114, a DB exporter: predictions processor 1116 and a DB exporter: status writer 1118. The DB exporter: driver 1114 triggers an export pipeline (e.g., exporting data from DB(s) 1112) for a given or current customer namespace. The respective export pipeline runs on a schedule (e.g., once a day). The DB exporter 1102, for example via the DB exporter: driver 1114, queries stored customer namespace data, stored for example in the predictions DB 1120. Querying stored customer namespace data includes reading their latest timestamp. The behavior-based predictive trait system 1020 (e.g., via the DB exporter 1102) also records the creation of a new job. In some examples, the DB exporter: predictions processor 1116 queries customer events and/or traits (e.g., from predictions DB 1120 or DB(s) 1112) incrementally, by date (only new events are processed). In some examples, the DB exporter: predictions processor 1116 exports data to a predictions datalake 1110. In some examples, the DB exporter: status writer 1118 completes the data export process, upserting the latest timestamp for the given or current customer namespace. In some examples, the predictions DB 1120 contains customer namespace information, predictive traits and/or trait values, as well as pipeline and data export states. The information stored in the predictions DB 1120 is retrieved, updated, or augmented by various workflows and/or pipelines as described above.

In some examples, the storage used by the behavior-based predictive trait system 1020, including the predictions DB 1120, the predictions datalake 1110, DB(s) 1112 and other storage, includes one or more storage types (e.g. Postgres DB, Oracle DB, MySQL DB, Amazon DynamoDB, MongoDB and other relational and non-relational DBs for the predictions DB 1120, an Apache Iceberg (or other solutions for large analytic tables) for predictions datalake 1110, BigQuery for DB(s) 1112, and other storage types.

In some examples, one or more of the pipelines in the behavior-based predictive trait system 1020 is implemented using a cloud-based machine learning service such as Amazon SageMaker, and a compute service such as AWS Lambda.

Feature Computation and/or Selection Considerations

In some examples, the data used to build a trait-specific ML model encompasses a time component, and therefore the behavior-based predictive trait system 1020 must define and enforce minimum history requirements for event streams used to derive features (e.g., during the featurization process). Such requirements are based on the set of one or more feature window sizes used during the featurization process. The behavior-based predictive trait system 1020 employs user inclusion criteria to ensure that target variables and/or features can be computed: for example, users are included in a training set or development set only if their activity meets a set of predefined thresholds, or based on other automatically tracked measures of user activity. In some examples, users with sparser activity patterns or no activity can be nevertheless incorporated, as the behavior-based predictive trait system 1020 uses a representation generator 202 that produces user embeddings using a pre-trained embedding model, thereby solving the cost-start problem (see, e.g., FIG. 2).

In some examples, appropriate feature selection/pruning (e.g., selecting top K features by correlation coefficient, using dimensionality reduction (e.g., via PCA) to decrease the effect of highly correlated features), automatic identification of features likely to contribute to overfitting, and other feature set analysis and transformation steps can be performed by the behavior-based predictive trait system 1020, as part of the training pipeline 1104 described below.

### Model Training and Evaluation Considerations

In some examples, the behavior-based predictive trait system 1020 trains one trait-specific model for users that have previously performed a target action (or were previously connected to a target event), and one model for users that have not previously performed the target action; the two models are then combined into a unified prediction model. Each of the respective user subpopulations can be required to meet predefined thresholds to guarantee a model can be trained. Such thresholds can be related to subpopulation size, activity levels per user, and other predefined user and user subpopulation inclusion criteria.

In some examples, when constructing the entries in the training set and/or evaluation set, the behavior-based predictive trait system 1020 derives a label for each example in the training/set based on set of binary labels derived from the occurrence of an event during a target window of time. In some examples, the behavior-based predictive trait system 1020 embeds time information encoded in the event in the label creation process.

In some examples, a behavior-based predictive trait system 1020 uses criteria, characteristics and/or other information provided by the system user in order to select a subpopulation of interest for model training. Additional criteria or logic can be implemented by the behavior-based predictive trait system 1020 to ensure congruence between model training and model inference phases.

In some examples, models trained by the behavior-based predictive trait system 1020 are compared against a relevant baseline, using traditional evaluation metrics (e.g., normalized cross entropy, hazard ratio, ROC-AUC, PR-AUC), or other evaluation metrics especially relevant for business lift. In some examples, a baseline is a univariate scaled score based on most correlated feature/event (extreme feature selection). In some examples, a model is deployed if its performance measured by a single metric is at least as good as the baseline performance and/or a previous trained model.

FIG. 12 is a flowchart illustrating a method 1200, according to some examples, as implemented by the representation generator 202 in the context of a behavior-based predictive trait system 1020.

At operation 1202, the representation generator 202 accesses, for each user of a set of users (e.g., an overall set of users), raw user event data comprising one or more user events. At operation 1204, the representation generator 202 generates, for each user of the set of users and based on executing an aggregation function, a document based on the raw user event data for each respective user. At operation 1206, the representation generator 202 computes, using a trained machine-learning (ML) model, user representations for each user in the set of users based on the generated user-specific documents.

At operation 1208, the representation generator 202 and/or the behavior-based predictive trait system 1020 detects, at a predictive trait user interface (UI), a selection of a predictive trait. At operation 1210, the behavior-based predictive trait system 1020 generates features for a predictive trait model based on a training set of users associated with computed user representations. In some examples, the training set of users is a subset of the set of users (see, e.g., at least operation 1202), and the associated user representations correspond to a subset of the user representations computed at operation 1206. In some examples, one or more of the training set users are not included in the set of users of operation 1202. For each such training set user, its corresponding user representation is computed using operations similar to 1204-1206, as applied to raw event data associated with the respective training set user.

### Feature Generation Examples

In some examples, the behavior-based predictive trait system 1020, for example via the feature generation component 212 directly generates features for the users in the training set based on the user representations of the users in the training set. For example, given a user embedding for a user, each embedding dimension can be directly converted into a feature. In some examples, the dimensions of the embedding vectors can be first reduced, for example by using methods such as Principal Component Analysis (PCA), t-SNE, or similar. Therefore, the number of features to be added can be reduced (for example, from hundreds of features to tens of features or fewer).

In some examples, the feature generation component 212 can cluster the set of users, and further compute cluster-based features to initialize, augment or replace a feature set for a user (for example, in the context of a predictive trait model). For example, given a set of N potentially overlapping clusters computed based on user embeddings, the feature generation component 212 can generate N cluster-based binary features. Given a user, a cluster of the N clusters, and a corresponding cluster-specific binary feature, the value of the feature for the user is 1 if the user is an element of the cluster, and 0 if not (other indicator values can also be used). In some examples, a cluster-specific feature can have, for a specific user, a value indicating how likely the user is to be an element in the cluster (e.g., a membership score, etc.) Alternative features can include an n-ary feature (here, n=N), where the value of the feature for a user corresponds to the most likely cluster of the N clusters for the given user, and so forth.

In some examples, the training set of users is a subset of the set of users, and the cluster-based features for each of the users in the training set are derived as above. In some examples, one or more of the users in the training set is not part of the set of users (e.g., in some cases, the set of users is a reference set of users, used to compute a reference set of user representations and/or reference set of N clusters). Given such a user in the training set and its corresponding user representation (computed as above). the feature generation component 212 can use a similarity-based approach to identify cluster-specific membership scores and/or indicators with respect to the N clusters. For example, the feature generation component 212 can compute a similarity measure (e.g., using cosine similarity, etc.) based on the user representation vector (e.g., the user embedding) and the centroid of each cluster. Each resulting similarity measure can indicate a raw cluster-specific membership score. Alternatively, the similarity measure can be converted into a cluster-specific binary feature (as above), by comparing it with one or more similarity scores between cluster elements and the cluster centroid, and respectively, one or more similarity scores between non-cluster elements and the cluster centroid. As above, alternative or additional features being generated for the user and user representation can include the n-ary feature (here, n=N), where the value of the feature corresponds to the most likely cluster of the N clusters for the user (e.g., based on the previously computed cluster-specific membership scores).

At operation 1212, the behavior-based predictive trait system 1020 trains the predictive trait model using at least the training set of users the features generated as described above (see operation 1210).

At operation 1214, the behavior-based predictive trait system 1020 computes, using the trained predictive trait model, predictive trait values for one or more users in a test set of users. In order to do so, the behavior-based predictive trait system 1020 computes a set of feature values for each user in the test set of users and each of the features identified at operation 1210. In some examples, the test set of users is a subset of the set of users (see, e.g., at least operation 1202), and the associated user representations for the users in the test set correspond to a subset of the user representations computed at operation 1206. In some examples, one or more of the test set users are not included in the set of users of operation 1202. For each such test set user, its corresponding user representation is computed using operations similar to 1204-1206, as applied to raw event data associated with the respective test set user. Given each user in the test set and its corresponding user representation, the behavior-based predictive trait system 1020 computes corresponding values for the features identified at operation 1210 for the predictive trait model. The values are computed as described in relation to operation 1210, except that the feature value computation is performed for each of the test set users rather than for each of the training set users as described above.

At operation 1216, the behavior-based predictive trait system 1020 displays, at the predictive trait UI, explanations with respect to the functionality and/or results and/or uses of the predictive trait model, where the explanations are computed based on one or more of the computed predictive trait values, the overall set of users, the training set of users, the test set of users, user representations for one or more of the sets of users, and so forth.

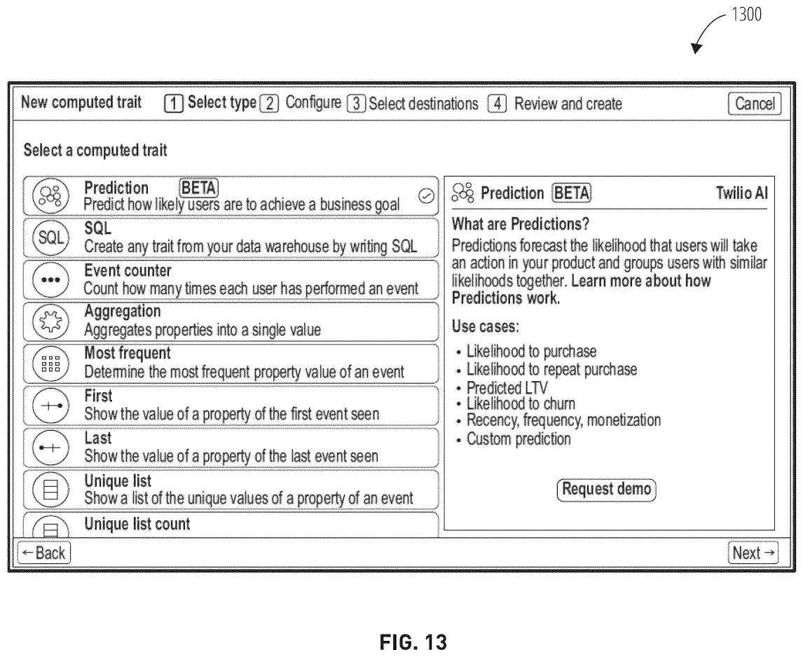

FIG. 13 is an illustration 1300 of a view of a UI for a behavior-based predictive trait system 1020, according to some examples. In some examples, as part of an onboarding phase, a system user (e.g., marketer) selects one or more user-selectable interface elements in order to choose a “prediction” mode and/or one of a set of traits of interest. In some examples, the system user can request a demo, or fill out a form as part of an onboarding phase.

The behavior-based predictive trait system 1020 can offer a set of core traits, such as likelihood to purchase, likelihood to repeat purchase, predictive LTV, propensity to churn, and other traits. The behavior-based predictive trait system 1020 allows the user to create and customize a custom prediction goal, or a custom trait.

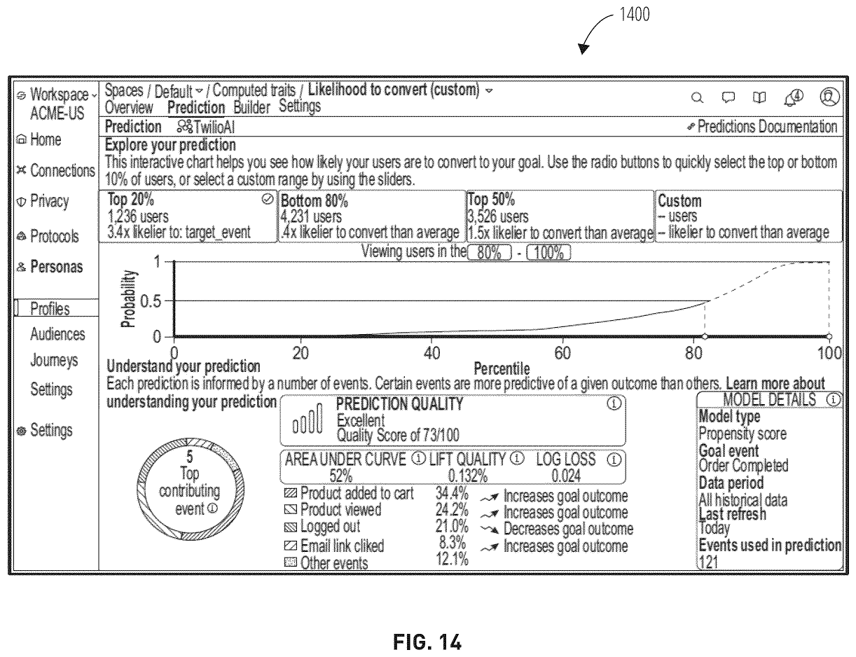

FIG. 14 illustrates a visualization 1400 of data related to trait prediction results within a UI for a behavior-based predictive trait system 1020, according to some examples. In some examples, a system user selects one or more user-selectable UI elements to choose a percentile to build a cohort (top K % users ranked by the probability that they will undertake the desired action, or convert to the marketer goal expressed for example as a target_event). In some examples, the behavior-based predictive trait system 1020 includes additional visualizations, such as for example a visualization of historical trait values, for example based on various aggregation functions or statistics computed over the population of users for which historical trait-related data is available, etc. In some examples, a visualization of historical trait values for only certain users of interest is be included.

In some examples, a UI for the behavior-based predictive trait system 1020 can include a visualization of the change in the trait prediction values (e.g., propensity scores) for one or more users (e.g., people in the set a customer is interested in). A user's trait prediction value can change periodically (e.g., weekly) based on the user's actions (e.g., interacting with one or more tracked websites). A visualization displayed within a UI for the behavior-based predictive trait system 1020 can show the overall trait prediction value for a set of people periodically changing (e.g., on a weekly basis): an average score for a user population (e.g., the average score varying over time), or track an collective measure of propensity scores (e.g., the propensity to purchase over time) as they change periodically (e.g., from week to week), based on new propensity scores) being computed. In some examples, percentile-level changes (e.g., changes in the top 10% cohort, bottom 10%, etc.) can be visualized. In some examples, visualizations use a min-max candle view.

In some examples, a UI for a behavior-based predictive trait system 1020 includes selected information about trait usage (particular steps in audience construction, journeys, etc.), trait growth and more. In some examples, the UI includes a visualization of data pertaining to the training and evaluation of the trait-specific model (feature information, feature weights, a score indicating prediction quality and other information pertaining to explainable AI-type functions or modules). For example, the UI can include a visualization of user representations used to derive features as described in FIG. 2 (see, e.g., at least the visualizer 216 discussion).

The user UI can also include data collection guidelines (either embedded in the UI or available in linked documentation) for customers, in order to improve quality and impact of the predictive trait models.

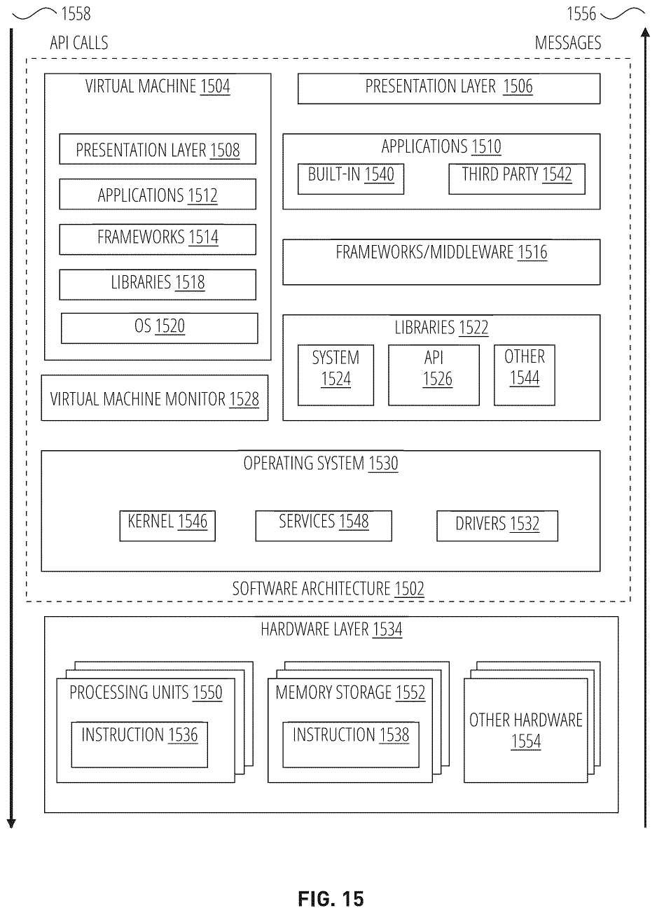

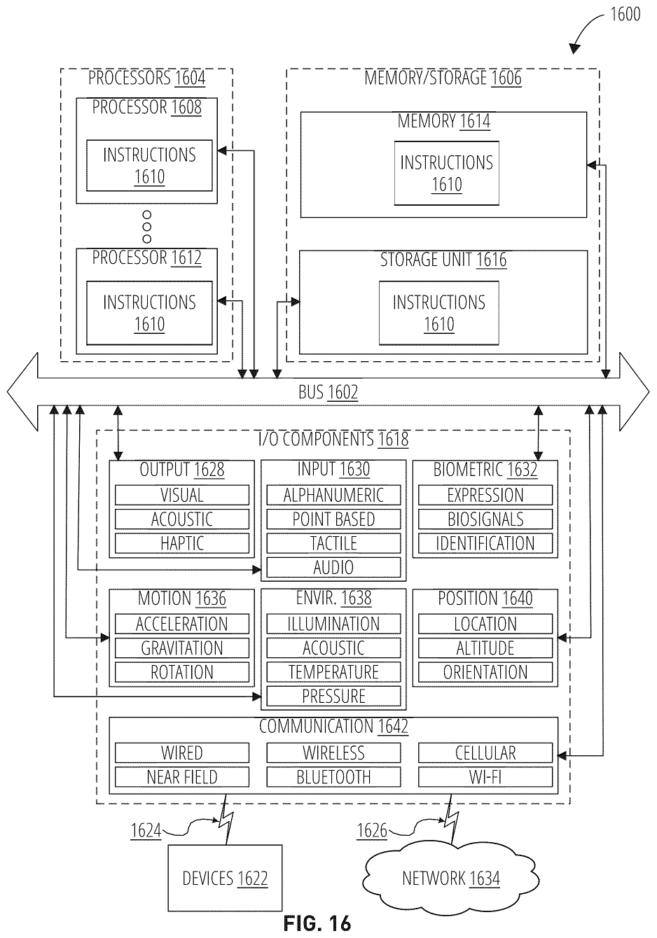

FIG. 15 is a block diagram illustrating an example of a software architecture 1502 that may be installed on a machine, according to some example embodiments. FIG. 15 is merely a non-limiting example of software architecture, and it will be appreciated that many other architectures may be implemented to facilitate the functionality described herein. The software architecture 1502 may be executing on hardware such as a machine 1600 of FIG. 16 that includes, among other things, processors 1604, memory/storage 1606, and input/output (I/O) components 1618. A representative hardware layer 1534 is illustrated and can represent, for example, the machine 1600 of FIG. 16. The representative hardware layer 1534 comprises one or more processing units 1550 having associated executable instructions 603. The executable instructions 603 represent the executable instructions of the software architecture 1502. The hardware layer 1534 also includes memory or storage 1052, which also have the executable instructions 1536. The hardware layer 1534 may also comprise other hardware 1554, which represents any other hardware of the hardware layer 1534, such as the other hardware illustrated as part of the machine 1600.

In the example architecture of FIG. 15, the software architecture 1502 may be conceptualized as a stack of layers, where each layer provides particular functionality. For example, the software architecture 1502 may include layers such as an operating system 1530, libraries 1518, frameworks/middleware 1516, applications 1510, and a presentation layer 1508. Operationally, the applications 1510 or other components within the layers may invoke API calls 1558 through the software stack and receive a response, returned values, and so forth (illustrated as messages 1556) in response to the API calls 1558. The layers illustrated are representative in nature, and not all software architectures have all layers. For example, some mobile or special-purpose operating systems may not provide a frameworks/middleware 1516 layer, while others may provide such a layer. Other software architectures may include additional or different layers.

The operating system 1530 may manage hardware resources and provide common services. The operating system 1530 may include, for example, a kernel 1546, services 1548, and drivers 1032. The kernel 1546 may act as an abstraction layer between the hardware and the other software layers. For example, the kernel 1546 may be responsible for memory management, processor management (e.g., scheduling), component management, networking, security settings, and so on. The services 1548 may provide other common services for the other software layers. The drivers 1532 may be responsible for controlling or interfacing with the underlying hardware. For instance, the drivers 1032 may include display drivers, camera drivers, Bluetooth® drivers, flash memory drivers, serial communication drivers (e.g., Universal Serial Bus (USB) drivers), Wi-Fi® drivers, audio drivers, power management drivers, and so forth depending on the hardware configuration.

The libraries 1518 may provide a common infrastructure that may be utilized by the applications 1510 and/or other components and/or layers. The libraries 1518 typically provide functionality that allows other software modules to perform tasks in an easier fashion than by interfacing directly with the underlying operating system 1530 functionality (e.g., kernel 1546, services 1548, or drivers 1032). The libraries 1518 (or libraries 1522) may include system libraries 1524 (e.g., C standard library) that may provide functions such as memory allocation functions, string manipulation functions, mathematic functions, and the like. In addition, the libraries 1518 may include API libraries 1526 such as media libraries (e.g., libraries to support presentation and manipulation of various media formats such as MPEG4, H.264, MP3, AAC, AMR, JPG, and PNG), graphics libraries (e.g., an OpenGL framework that may be used to render 2D and 3D graphic content on a display), database libraries (e.g., SQLite that may provide various relational database functions), web libraries (e.g., WebKit that may provide web browsing functionality), and the like. The libraries 1518 or libraries 1522 may also include a wide variety of other libraries 1544 to provide many other APIs to the applications 1510 and other software components/modules.

The frameworks 1514 (also sometimes referred to as middleware) may provide a higher-level common infrastructure that may be utilized by the applications 1510 or other software components/modules. For example, the frameworks 1514 may provide various graphical user interface functions, high-level resource management, high-level location services, and so forth. The frameworks 1514 may provide a broad spectrum of other APIs that may be utilized by the applications 1510 and/or other software components/modules, some of which may be specific to a particular operating system or platform.

The applications 1510 include built-in applications and/or third-party applications 642. Examples of representative built-in applications 1540 may include, but are not limited to, a home application, a contacts application, a browser application, a book reader application, a location application, a media application, a messaging application, or a game application.

The third-party applications 1542 may include any of the built-in applications 1540, as well as a broad assortment of other applications. In a specific example, the third-party applications 1542 (e.g., an application developed using the Android™ or iOS™ software development kit (SDK) by an entity other than the vendor of the particular platform) may be mobile software running on a mobile operating system such as iOS™, Android™, or other mobile operating systems. In this example, the third-party applications 1542 may invoke the API calls 1558 provided by the mobile operating system such as the operating system 1530 to facilitate functionality described herein.

The applications 1510 may utilize built-in operating system functions, libraries (e.g., system libraries 1524, API libraries 1526, and other libraries 1544), or frameworks/middleware 1516 to create user interfaces to interact with users of the system. Alternatively, or additionally, in some systems, interactions with a user may occur through a presentation layer, such as the presentation layer 1508. In these systems, the application/module “logic” can be separated from the aspects of the application/module that interact with the user.

Some software architectures utilize virtual machines. In the example of FIG. 15, this is illustrated by a virtual machine 1504. The virtual machine 1504 creates a software environment where applications/modules can execute as if they were executing on a hardware machine. The virtual machine 1504 is hosted by a host operating system (e.g., the operating system 1530) and typically, although not always, has a virtual machine monitor 1528, which manages the operation of the virtual machine 1504 as well as the interface with the host operating system (e.g., the operating system 1530). A software architecture executes within the virtual machine 1504, such as an operating system 1530, libraries 1518, frameworks/middleware 1516, applications 1512, or a 1508. These layers of software architecture executing within the virtual machine 1504 can be the same as corresponding layers previously described or may be different.

FIG. 16 is a block diagram illustrating components of a machine 1600, according to some example embodiments, able to read instructions from a machine-readable medium (e.g., a machine-readable storage medium) and perform any one or more of the methodologies discussed herein. Specifically, FIG. 16 shows a diagrammatic representation of the machine 1600 in the example form of a computer system, within which instructions 1610 (e.g., software, a program, an application, an applet, an app, or other executable code) for causing the machine 1600 to perform any one or more of the methodologies discussed herein may be executed. As such, the instructions 1610 may be used to implement modules or components described herein. The instructions 1610 transform the general, non-programmed machine 1600 into a particular machine 1600 to carry out the described and illustrated functions in the manner described. In alternative embodiments, the machine 1600 operates as a standalone device or may be coupled (e.g., networked) to other machines. In a networked deployment, the machine 1600 may operate in the capacity of a server machine or a client machine in a server-client network environment, or as a peer machine in a peer-to-peer (or distributed) network environment. The machine 1600 may comprise, but not be limited to, a server computer, a client computer, a personal computer (PC), a tablet computer, a laptop computer, a netbook, a personal digital assistant (PDA), an entertainment media system, a cellular telephone, a smart phone, a mobile device, a wearable device (e.g., a smart watch), other smart devices, a web appliance, a network router, a network switch, a network bridge, or any machine capable of executing the instructions 1610, sequentially or otherwise, that specify actions to be taken by machine 1600. Further, while only a single machine 1600 is illustrated, the term “machine” shall also be taken to include a collection of machines that individually or jointly execute the instructions 1610 to perform any one or more of the methodologies discussed herein.

The machine 1600 may include processors 1604, memory/storage 1606, and I/O components 1618, which may be configured to communicate with each other such as via a bus 1602. The memory/storage 1606 may include a memory 1614, such as a main memory, or other memory storage, and a storage unit 1616, both accessible to the processors 1604 such as via the bus 1602. The storage unit 1616 and memory 1614 store the instructions 1610 embodying any one or more of the methodologies or functions described herein. The instructions 1610 may also reside, completely or partially, within the memory 1614 within the storage unit 1616, within at least one of the processors 1604 (e.g., within the processor's cache memory), or any suitable combination thereof, during execution thereof by the machine 1600. Accordingly, the memory 1614, the storage unit 1616, and the memory of processors 1604 are examples of machine-readable media.

The I/O components 1618 may include a wide variety of components to receive input, provide output, produce output, transmit information, exchange information, capture measurements, and so on. The specific I/O components 1618 that are included in a particular machine 1600 will depend on the type of machine. For example, portable machines such as mobile phones will likely include a touch input device or other such input mechanisms, while a headless server machine will likely not include such a touch input device. It will be appreciated that the I/O components 1618 may include many other components that are not shown in FIG. 11. The I/O components 1618 are grouped according to functionality merely for simplifying the following discussion and the grouping is in no way limiting. In various example embodiments, the I/O components 1618 may include output components 1628 and input components 1630. The output components 1628 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 1630 may include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or other pointing instrument), tactile input components (e.g., a physical button, a touch screen that provides location and/or force of touches or touch gestures, or other tactile input components), audio input components (e.g., a microphone), and the like.

In further example embodiments, the I/O components 1618 may include biometric components 1632, motion components 1636, environmental environment components 1638, or position components 1640 among a wide array of other components. For example, the biometric components 1632 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 1636 may include acceleration sensor components (e.g., accelerometer), gravitation sensor components, rotation sensor components (e.g., gyroscope), and so forth. The environment components 1638 may include, for example, illumination sensor components (e.g., photometer), temperature sensor components (e.g., one or more thermometer that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 1640 may include location sensor components (e.g., a Global Position system (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 1618 may include communication components 1642 operable to couple the machine 1600 to a network 1634 or devices 1622 via coupling 1624 and coupling 1626 respectively. For example, the communication components 1642 may include a network interface component or other suitable device to interface with the network 1634. In further examples, communication components 1642 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 1622 may be another machine or any of a wide variety of peripheral devices (e.g., a peripheral device coupled via a Universal Serial Bus (USB)).

Moreover, the communication components 1642 may detect identifiers or include components operable to detect identifiers. For example, the communication components 1642 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 1642, such as, location via Internet Protocol (IP) geo-location, location via Wi-Fi® signal triangulation, location via detecting a NFC beacon signal that may indicate a particular location, and so forth.

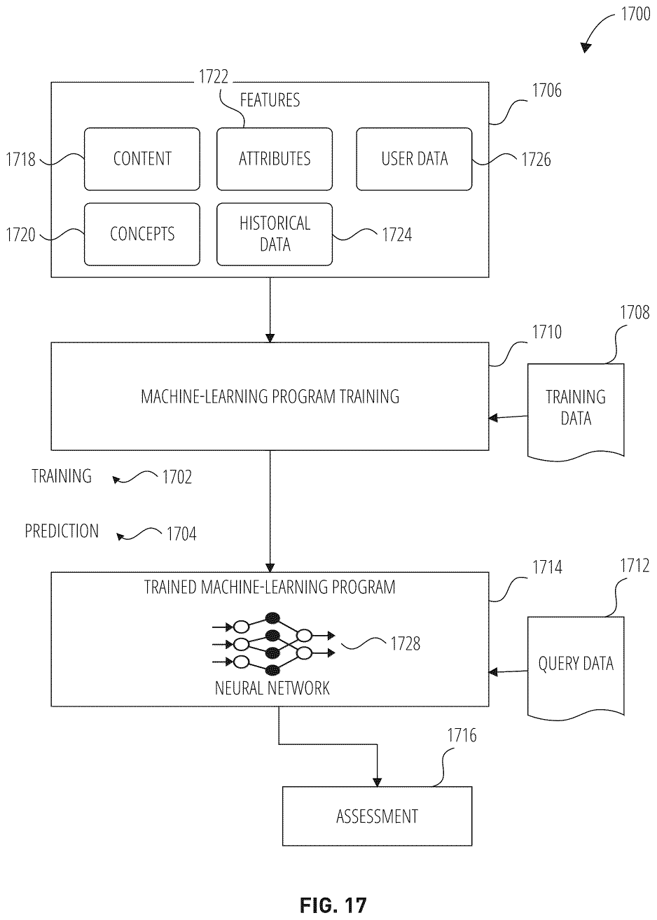

FIG. 17 is a block diagram showing a machine-learning program 1700 according to some examples. The machine-learning programs 1700, also referred to as machine-learning algorithms or tools, are used as part of the behavior-based predictive trait system 1020 system described herein, for instance to perform operations of trait-specific machine learning models (see FIG. 10 and FIG. 11).

Machine learning is a field of study that gives computers the ability to learn without being explicitly programmed. Machine learning explores the study and construction of algorithms, also referred to herein as tools, that may learn from or be trained using existing data and make predictions about or based on new data. Such machine-learning tools operate by building a model from example training data 1708 in order to make data-driven predictions or decisions expressed as outputs or assessments (e.g., assessment 1716). Although examples are presented with respect to a few machine-learning tools, the principles presented herein may be applied to other machine-learning tools.

In some examples, different machine-learning tools may be used. For example, Logistic Regression (LR), Naive-Bayes, Random Forest (RF), Gradient Boosted Decision Trees (GBDT), neural networks (NN), matrix factorization, and Support Vector Machines (SVM) tools may be used. In some examples, one or more ML paradigms may be used: binary or n-ary classification, semi-supervised learning, etc. In some examples, time-to-event (TTE) data will be used during model training. In some examples, a hierarchy or combination of models (e.g. stacking, bagging) may be used.

Two common types of problems in machine learning are classification problems and regression problems. Classification problems, also referred to as categorization problems, aim at classifying items into one of several category values (for example, is this object an apple or an orange?). Regression algorithms aim at quantifying some items (for example, by providing a value that is a real number).

The machine-learning program 1700 supports two types of phases, namely a training phases 1702 and prediction phases 1704. In training phases 1702, supervised learning, unsupervised or reinforcement learning may be used. For example, the machine-learning program 1700 (1) receives features 1706 (e.g., as structured or labeled data in supervised learning) and/or (2) identifies features 1706 (e.g., unstructured or unlabeled data for unsupervised learning) in training data 1708 In prediction phases 1704, the machine-learning program 1700 uses the features 1706 for analyzing query data 1712 to generate outcomes or predictions, as examples of an assessment 1716.

In the training phase 1702, feature engineering is used to identify features 1706 and may include identifying informative, discriminating, and independent features for the effective operation of the machine-learning program 1700 in pattern recognition, classification, and regression. In some examples, the training data 1708 includes labeled data, which is known data for pre-identified features 1706 and one or more outcomes. Each of the features 17066 may be a variable or attribute, such as individual measurable property of a process, article, system, or phenomenon represented by a data set (e.g., the training data 1708). Features 1706 may also be of different types, such as numeric features, strings, and graphs, and may include one or more of content 1718, concepts 1720, attributes 1722, historical data 1724 and/or user data 1726, merely for example.

In training phases 1702, the machine-learning program 1700 uses the training data 1708 to find correlations among the features 1706 that affect a predicted outcome or assessment 1716

With the training data 1708 and the identified features 1706, the machine-learning program 1700 is trained during the training phase 1702 at machine-learning program training 1710. The machine-learning program 1700 appraises values of the features 1706 as they correlate to the training data 1708. The result of the training is the trained machine-learning program 1714 (e.g., a trained or learned model).

Further, the training phases 1702 may involve machine learning, in which the training data 1708 is structured (e.g., labeled during preprocessing operations), and the trained machine-learning program 1714 implements a relatively simple neural network 1728 (or one of other machine learning models, as described herein) capable of performing, for example, classification and clustering operations. In other examples, the training phase 1702 may involve deep learning, in which the training data 1708 is unstructured, and the trained machine-learning program 1714 implements a deep neural network 1728 that is able to perform both feature extraction and classification/clustering operations.

A neural network 1728 generated during the training phase 1702, and implemented within the trained machine-learning program 1714, may include a hierarchical (e.g., layered) organization of neurons. For example, neurons (or nodes) may be arranged hierarchically into a number of layers, including an input layer, an output layer, and multiple hidden layers. The layers within the neural network 1728 can have one or many neurons, and the neurons operationally compute a small function (e.g., activation function). For example, if an activation function generates a result that transgresses a particular threshold, an output may be communicated from that neuron (e.g., transmitting neuron) to a connected neuron (e.g., receiving neuron) in successive layers. Connections between neurons also have associated weights, which define the influence of the input from a transmitting neuron to a receiving neuron.

In some examples, the neural network 1728 may also be one of a number of different types of neural networks, such as a single-layer feed-forward network, a Multilayer Perceptron (MLP), an Artificial Neural Network (ANN), a Recurrent Neural Network (RNN), a Long Short-Term Memory Network (LSTM), a Bidirectional Neural Network, a symmetrically connected neural network, a Deep Belief Network (DBN), a Convolutional Neural Network (CNN), a Generative Adversarial Network (GAN), an Autoencoder Neural Network (AE), a Restricted Boltzmann Machine (RBM), a Hopfield Network, a Self-Organizing Map (SOM), a Radial Basis Function Network (RBFN), a Spiking Neural Network (SNN), a Liquid State Machine (LSM), an Echo State Network (ESN), a Neural Turing Machine (NTM), or a Transformer Network, merely for example.

During prediction phases 1704 the trained machine-learning program 1714 is used to perform an assessment. Query data 1712 is provided as an input to the trained machine-learning program 1714, and the trained machine-learning program 1714 generates the assessment 1716 as output, responsive to receipt of the query data 1712.

In some examples, the trained machine-learning program 1714 may be a generative artificial intelligence (AI) model. Generative AI is a term that may refer to any type of artificial intelligence that can create new content from training data 1708. For example, generative AI can produce text, images, video, audio, code, or synthetic data similar to the original data but not identical.

Some of the techniques that may be used in generative AI are:
1. Convolutional Neural Networks (CNNs): CNNs may be used for image recognition and computer vision tasks. CNNs may, for example, be designed to extract features from images by using filters or kernels that scan the input image and highlight important patterns.
2. Recurrent Neural Networks (RNNs): RNNs may be used for processing sequential data, such as speech, text, and time series data, for example. RNNs employ feedback loops that allow them to capture temporal dependencies and remember past inputs.
3. Generative adversarial networks (GANs): GNNs may include two neural networks: a generator and a discriminator. The generator network attempts to create realistic content that can “fool” the discriminator network, while the discriminator network attempts to distinguish between real and fake content. The generator and discriminator networks compete with each other and improve over time.
4. Variational autoencoders (VAEs): VAEs may encode input data into a latent space (e.g., a compressed representation) and then decode it back into output data. The latent space can be manipulated to generate new variations of the output data. VAEs may use self-attention mechanisms to process input data, allowing them to handle long text sequences and capture complex dependencies.
5. Transformer models: Transformer models may use attention mechanisms to learn the relationships between different parts of input data (such as words or pixels) and generate output data based on these relationships. Transformer models can handle sequential data, such as text or speech, as well as non-sequential data, such as images or code.

In generative AI examples, the output prediction/inference data include predictions, translations, summaries or media content.

In some generative AI examples, the trained machine-learning program 1714 can be a Large Language Model (LLM). LLMs can perform tasks such as recognizing, translating, predicting, or generating text (or other content), and can be used for text classification, question answering, document summarization, text generation, as well as plan generation, code generation, prediction problems (e.g., predicting protein structures), and so forth. Examples of LLMs include GPT-3.5, GPT-4, Bard, Cohere, PaLM, Falcon, Claude, Llama, Orca, Phi-1, Jurassic and more.

### Examples

Example 1 is a system comprising: at least one processor; and at least one memory component storing instructions that, when executed by the at least one processor, cause the at least one processor to perform operations comprising: accessing, for each user of a set of users, user event data representing one or more user events; generating, for each user of the set of users, a document including a result of executing an aggregation function on the user event data for the user; computing, for each user of the set of users, a user representation by using a trained machine-learning (ML) model and a generated document corresponding to the user; and responsive to detecting, at a predictive trait user interface (UI), a selection of a predictive trait: generating features for a predictive trait model based on a training set of users; training the predictive trait model using the generated features; computing, using the trained predictive trait model, predictive trait values for each user in a test set of users; and displaying, at the predictive trait UI, explanations computed based on one or more of at least the computed predictive trait values, the training set of users, the test set of users, and the user representations.

In Example 2, the subject matter of Example 1 includes, wherein: executing the aggregation function on the user event data further comprises aggregating the user event data based on one or more intervals of a predetermined time window to generate aggregated user event data representing one or more aggregated user events; and wherein generating the document for the user further comprises: determining, for each aggregated user event of the aggregated user events, event data to be included in the respective document; and including, for each aggregated user event of the aggregated user events, the determined event data in the respective document, the including further using a predetermined ordering criterion for the aggregated user events.

In Example 3, the subject matter of Example 2 includes, wherein the event data associated with the aggregated user event comprises at least one of text data associated with the aggregated user event or a frequency count indicating a number of times a user event occurred during an interval of the one or more intervals.

In Example 4, the subject matter of Example 3 includes, wherein the text data associated with the aggregated user event comprises one or more of data representing an event name, data representing an event description, or data representing a URL associated with the event.

In Example 5, the subject matter of Examples 1~4 includes, wherein the trained ML model is a pre-trained embedding model, and wherein computing the user representation comprises generating a user embedding with a preselected number of dimensions for each user based on the generated document for the respective user.

In Example 6, the subject matter of Examples 1-5 includes, wherein the training set of users is a first subset of the set of users and the test set of users is a second subset of the set of users.

In Example 7, the subject matter of Examples 1-6 includes, wherein the operations further comprise clustering user representations computed for the set of users to generate user representation clusters; and wherein generating features for the predictive trait model comprises generating features based on the user representation clusters and the training set.

In Example 8, the subject matter of Example 7 includes, wherein generating features based on the user representation clusters comprises generating, for each cluster of the user representation cluster, a binary feature, wherein a value of the binary feature for a user indicates whether a corresponding user representation is an element of the cluster.

In Example 9, the subject matter of Examples 7-8 includes, wherein generating features based on the user representation clusters comprises generating, for each cluster, an n-ary feature, wherein the value of the n-ary feature for a given user corresponds to a selection of a cluster of the user representation clusters for the given user.

In Example 10, the subject matter of Examples 1-9 includes, wherein the predictive trait UI further provides selectable UI elements enabling configuring a custom predictive trait, the configuring comprising: specifying a condition requiring or precluding a first user action of a set of recordable user actions; configuring a time window indicating a time period relative to the first user action being recorded; and specifying a second user action of a set of recordable user actions, the value of the custom predictive trait corresponding to a Boolean flag indicating whether the second user action is recorded during the time window.

In Example 11, the subject matter of Examples 1-10 includes, wherein generating explanations comprises one or more of at least: generating feature importance explanations indicating relative importance of features in generating the trained predictive trait model; computing percentile statistics corresponding to a distribution of the computed predictive trait values over a population of users; and generating a visualization of user representation clusters for the population of users.

Example 12 is at least one non-transitory machine-readable medium (computer-readable medium) including instructions that, when executed by processing circuitry, cause the processing circuitry to perform operations to implement of any of Examples 1-11.

Example 13 is an apparatus comprising means to implement any of Examples 1-11.

Example 14 is a computer-implemented method to implement any of Examples 1-11.

### Glossary

“CARRIER SIGNAL” in this context refers to any intangible medium that is capable of storing, encoding, or carrying instructions for execution by the machine, and includes digital or analog communications signals or other intangible medium to facilitate communication of such instructions. Instructions may be transmitted or received over the network using a transmission medium via a network interface device and using any one of a number of well-known transfer protocols.

“CLIENT DEVICE” in this context refers to any machine that interfaces to a communications network to obtain resources from one or more server systems or other client devices. A client device may be, but is not limited to, a mobile phone, desktop computer, laptop, portable digital assistants (PDAs), smart phones, tablets, ultra books, netbooks, laptops, multi-processor systems, microprocessor-based or programmable consumer electronics, game consoles, set-top boxes, or any other communication device that a user may use to access a network.

“COMMUNICATIONS NETWORK” in this context refers to one or more portions of a network that may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, a network or a portion of a network may include a wireless or cellular network and the coupling may be a Code Division Multiple Access (CDMA) connection, a Global System for Mobile communications (GSM) connection, or other type of cellular or wireless coupling. In this example, the coupling may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard setting organizations, other long range protocols, or other data transfer technology.

“MACHINE-READABLE MEDIUM” in this context refers to a component, device or other tangible media able to store instructions and data temporarily or permanently and may include, but is not be limited to, random-access memory (RAM), read-only memory (ROM), buffer memory, flash memory, optical media, magnetic media, cache memory, other types of storage (e.g., Erasable Programmable Read-Only Memory (EEPROM)) and/or any suitable combination thereof. The term “machine-readable medium” should be taken to include a single medium or multiple media (e.g., a centralized or distributed database, or associated caches and servers) able to store instructions. The term “machine-readable medium” shall also be taken to include any medium, or combination of multiple media, that is capable of storing instructions (e.g., code) for execution by a machine, such that the instructions, when executed by one or more processors of the machine, cause the machine to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

“COMPONENT” in this context refers to a device, physical entity or logic having boundaries defined by function or subroutine calls, branch points, application program interfaces (APIs), or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components. A “hardware component” is a tangible unit capable of performing certain operations and may be configured or arranged in a certain physical manner. In various example embodiments, one or more computer systems (e.g., a standalone computer system, a client computer system, or a server computer system) or one or more hardware components of a computer system (e.g., a processor or a group of processors) may be configured by software (e.g., an application or application portion) as a hardware component that operates to perform certain operations as described herein. A hardware component may also be implemented mechanically, electronically, or any suitable combination thereof. For example, a hardware component may include dedicated circuitry or logic that is permanently configured to perform certain operations. A hardware component may be a special-purpose processor, such as a Field-Programmable Gate Array (FPGA) or an Application Specific Integrated Circuit (ASIC). A hardware component may also include programmable logic or circuitry that is temporarily configured by software to perform certain operations. For example, a hardware component may include software executed by a general-purpose processor or other programmable processor. Once configured by such software, hardware components become specific machines (or specific components of a machine) uniquely tailored to perform the configured functions and are no longer general-purpose processors. It will be appreciated that the decision to implement a hardware component mechanically, in dedicated and permanently configured circuitry, or in temporarily configured circuitry (e.g., configured by software) may be driven by cost and time considerations. Accordingly, the phrase “hardware component” (or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware components are temporarily configured (e.g., programmed), each of the hardware components need not be configured or instantiated at any one instance in time. For example, where a hardware component comprises a general-purpose processor configured by software to become a special-purpose processor, the general-purpose processor may be configured as respectively different special-purpose processors (e.g., comprising different hardware components) at different times. Software accordingly configures a particular processor or processors, for example, to constitute a particular hardware component at one instance of time and to constitute a different hardware component at a different instance of time. Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In embodiments in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information). The various operations of example methods described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions described herein. As used herein, “processor-implemented component” refers to a hardware component implemented using one or more processors. Similarly, the methods described herein may be at least partially processor-implemented, with a particular processor or processors being an example of hardware. For example, at least some of the operations of a method may be performed by one or more processors or processor-implemented components. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an Application Program Interface (API)). The performance of certain of the operations may be distributed among the processors, not only residing within a single machine, but deployed across a number of machines. In some example embodiments, the processors or processor-implemented components may be located in a single geographic location (e.g., within a home environment, an office environment, or a server farm). In other example embodiments, the processors or processor-implemented components may be distributed across a number of geographic locations.

“PROCESSOR” in this context refers to any circuit or virtual circuit (a physical circuit emulated by logic executing on an actual processor) that manipulates data values according to control signals (e.g., “commands”, “op codes”, “machine code”, etc.) and which produces corresponding output signals that are applied to operate a machine. A processor may, for example, be a Central Processing Unit (CPU), a Reduced Instruction Set Computing (RISC) processor, a Complex Instruction Set Computing (CISC) processor, a Graphics Processing Unit (GPU), a Digital Signal Processor (DSP), an Application Specific Integrated Circuit (ASIC), a Radio-Frequency Integrated Circuit (RFIC) or any combination thereof. A processor may further be a multi-core processor having two or more independent processors (sometimes referred to as “cores”) that may execute instructions contemporaneously.

“TIMESTAMP” in this context refers to a sequence of characters or encoded information identifying when a certain event occurred, for example giving date and time of day, sometimes accurate to a small fraction of a second.

“TIME DELAYED NEURAL NETWORK (TDNN)” in this context, a TDNN is an artificial neural network architecture whose primary purpose is to work on sequential data. An example would be converting continuous audio into a stream of classified phoneme labels for speech recognition.

“BI-DIRECTIONAL LONG-SHORT TERM MEMORY (BLSTM)” in this context refers to a recurrent neural network (RNN) architecture that remembers values over arbitrary intervals. Stored values are not modified as learning proceeds. RNNs allow forward and backward connections between neurons. BLSTM are well-suited for the classification, processing, and prediction of time series, given time lags of unknown size and duration between events.

“TRAINING SET” and “TEST SET” in this context are understood in the context of typical ML model development. A development set is selected and properly split into train/validation/test sets. The training set may refer to a “train/validation” set. The test set may refer to a “test/evaluation” or “test/assessment” set. In some examples, properly splitting the development set takes into account temporal dependencies, for example corresponding to the time series nature of the event streams, or the tracked user behaviors.

Throughout this specification, plural instances may implement resources, components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components.

As used herein, the term “or” may be construed in either an inclusive or exclusive sense. The terms “a” or “an” should be read as meaning “at least one,” “one or more,” or the like. The presence of broadening words and phrases such as “one or more,” “at least,” “but not limited to,” or other like phrases in some instances shall not be read to mean that the narrower case is intended or required in instances where such broadening phrases may be absent. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. The specification and drawings are, accordingly, to be regarded in an illustrative rather than a restrictive sense.

It will be understood that changes and modifications may be made to the disclosed embodiments without departing from the scope of the present disclosure. These and other changes or modifications are intended to be included within the scope of the present disclosure.

What is claimed is:

1. A system comprising:
at least one processor; and
at least one memory component storing instructions that, when executed by the at least one processor, cause the at least one processor to perform operations comprising:
accessing, for each user of a set of users, user event data representing one or more user events;
generating, for each user of the set of users, a document including a result of executing an aggregation function on the user event data for the user;
computing, for each user of the set of users, a user representation by using a trained machine-learning (ML) model and a generated document corresponding to the user; and
responsive to detecting, at a predictive trait user interface (UI), a selection of a predictive trait:
generating features for a predictive trait model based on a training set of users;
training the predictive trait model using the generated features;
computing, using the trained predictive trait model, predictive trait values for each user in a test set of users; and
displaying, at the predictive trait UI, explanations computed based on one or more of at least the computed predictive trait values, the training set of users, the test set of users, and the user representations.

2. The system of claim 1, wherein:
executing the aggregation function on the user event data further comprises aggregating the user event data based on one or more intervals of a predetermined time window to generate aggregated user event data representing one or more aggregated user events; and wherein
generating the document for the user further comprises:
determining, for each aggregated user event of the aggregated user events, event data to be included in the respective document; and
including, for each aggregated user event of the aggregated user events, the determined event data in the respective document, the including further using a predetermined ordering criterion for the aggregated user events.

3. The system of claim 2, wherein the event data associated with the aggregated user event comprises at least one of text data associated with the aggregated user event or a frequency count indicating a number of times a user event occurred during an interval of the one or more intervals.

4. The system of claim 3, wherein the text data associated with the aggregated user event comprises one or more of data representing an event name, data representing an event description, or data representing a URL associated with the event.

5. The system of claim 1, wherein the trained ML model is a pre-trained embedding model, and wherein computing the user representation comprises generating a user embedding with a preselected number of dimensions for each user based on the generated document for the respective user.

6. The system of claim 1, wherein the training set of users is a first subset of the set of users and the test set of users is a second subset of the set of users.

7. The system of claim 1, wherein the operations further comprise clustering user representations computed for the set of users to generate user representation clusters; and wherein generating features for the predictive trait model comprises generating features based on the user representation clusters and the training set.

8. The system of claim 7, wherein generating features based on the user representation clusters comprises generating, for each cluster of the user representation cluster, a binary feature, wherein a value of the binary feature for a user indicates whether a corresponding user representation is an element of the cluster.

9. The system of claim 7, wherein generating features based on the user representation clusters comprises generating, for each cluster, an n-ary feature, wherein the value of the n-ary feature for a given user corresponds to a selection of a cluster of the user representation clusters for the given user.

10. The system of claim 1, wherein the predictive trait UI further provides selectable UI elements enabling configuring a custom predictive trait, the configuring comprising:
specifying a condition requiring or precluding a first user action of a set of recordable user actions;
configuring a time window indicating a time period relative to the first user action being recorded; and
specifying a second user action of a set of recordable user actions, the value of the custom predictive trait corresponding to a Boolean flag indicating whether the second user action is recorded during the time window.

11. The system of claim 1, wherein generating explanations comprises one or more of at least:
generating feature importance explanations indicating relative importance of features in generating the trained predictive trait model;
computing percentile statistics corresponding to a distribution of the computed predictive trait values over a population of users; and
generating a visualization of user representation clusters for the population of users.

12. A computer-implemented method, comprising:
accessing, for each user of a set of users, user event data representing one or more user events;
generating, for each user of the set of users, a document including a result of executing an aggregation function on the user event data for the user;
computing, for each user of the set of users, a user representation by using a trained machine-learning (ML) model and a generated document corresponding to the user; and
responsive to detecting, at a predictive trait user interface (UI), a selection of a predictive trait:
generating features for a predictive trait model based on a training set of users;
training the predictive trait model using the generated features;
computing, using the trained predictive trait model, predictive trait values for each user in a test set of users; and
displaying, at the predictive trait UI, explanations computed based on one or more of at least the computed predictive trait values, the training set of users, the test set of users, and the user representations.

13. The computer-implemented method of claim 12, wherein executing the aggregation function on the user event data comprises aggregating the user event data based on one or more intervals of a predetermined time window to generate aggregated user event data representing one or more aggregated user events; and wherein
generating the document for the user further comprises:
determining, for each aggregated user event of the aggregated user events, event data to be included in the respective document; and
including, for each aggregated user event of the aggregated user events, the determined event data in the respective document, the including further using a predetermined ordering criterion for the aggregated user events.

14. The method of claim 13, wherein the event data associated with the aggregated user event comprises at least one of text data associated with the aggregated user event or a frequency count indicating a number of times a user event occurred during an interval of the one or more intervals.

15. The method of claim 14, wherein the text data associated with the aggregated user event comprises one or more of data representing an event name, data representing an event description, or text representing a URL associated with the event.

16. The method of claim 12, wherein the trained ML model is a pre-trained embedding model, and wherein computing the user representation comprises generating a user embedding vector with a preselected number of dimensions for each user based on the generated document for the respective user.

17. The method of claim 12, the method further comprising clustering user representations computed for the set of users to generate user representation clusters; and wherein generating features for the predictive trait model comprises generating features based on the user representation clusters and the training set.

18. The method of claim 17, wherein generating features based on the user representation clusters comprises generating, for each cluster of the user representation cluster, a binary feature, wherein a value of the binary feature for a user indicates whether a corresponding user representation is an element of the cluster.

19. The method of claim 17, wherein generating features based on the user representation clusters comprises generating, for each cluster, an n-ary feature, wherein the value of the n-ary feature for a given user corresponds to a selection of a cluster of the user representation clusters for the given user.

20. A non-transitory computer-readable storage medium, the computer-readable storage medium including instructions that when executed by a computer, cause the computer to:
access, for each user of a set of users, user event data representing one or more user events;
generate, for each user of the set of users, a document including a result of executing an aggregation function on the user event data for the user;
compute, for each user of the set of users, a user representation by using a trained machine-learning (ML) model and a generated document corresponding to the user; and
responsive to detecting, at a predictive trait user interface (UI), a selection of a predictive trait:
generate features for a predictive trait model based on a training set of users;
train the predictive trait model using the generated features;
compute, using the trained predictive trait model, predictive trait values for each user in a test set of users; and
display, at the predictive trait UI, explanations computed based on one or more of at least the computed predictive trait values, the training set of users, the test set of users, and the user representations.
